(19) United States
(12) Patent Application Publication
(10) Pub. No.: US 2014/0304090 A1
(43) Pub. Date: Oct. 9, 2014

(54) APPARATUS AND METHOD FOR PROVIDING ELECTRONIC BOOK SERVICE IN ELECTRONIC BOOK SYSTEM

(71) Applicants: Young-Wan So, Gunpo-si (KR); Young-Sun Ryu, Seongnam-si (KR)

(72) Inventors: Young-Wan So, Gunpo-si (KR); Young-Sun Ryu, Seongnam-si (KR)

(21) Appl. No.: 14/365,445

(22) PCT Filed: Dec. 14, 2012
(86) PCT No.: PCT/KR2012/010965

§ 371 Date: Jun. 13, 2014

(30) Foreign Application Priority Data
Dec. 14, 2011 (KR) 10-2011-0134632
Dec. 28, 2011 (KR) 10-2011-0144091
Dec. 28, 2011 (KR) 10-2011-0144276

(51) Int. Cl. H04L 29/06; H04L 29/08; G06Q 30/02

(52) U.S. Cl. CPC H04L 67/42; G06Q 30/0276; H04L 67/306
USPC 705/14.72; 709/203

(57) ABSTRACT

A method for providing a multiplay electronic book content of a client in an electronic book system is provided. The method includes receiving, from an electronic book content server, a multiplay profile and a multiplayable electronic book content which is an electronic book content including multiplay characteristic information, and editing the multiplayable electronic book content so that the content corresponds to a user profile so as to generate a multiplay electronic book content. The multiplay profile includes at least one multiplay parameter which is information regarding the characteristics of relevant electronic book content. The multiplay characteristic information indicates information for tagging which sub-content included in the multiplayable electronic book content corresponds to which multiplay parameter from among said at least one multiplay parameter. The user profile includes at least one user parameter which is information regarding the characteristics of electronic book content with which the client intends to be provided.

### CROSS-REFERENCE TO RELATED APPLICATION(S)

This application is a U.S. National Stage application under 35 U.S.C. §371 of an International application filed on Dec. 14, 2012 and assigned application number PCT/KR2012/010965, which claimed the benefit of a Korean patent application filed on Dec. 14, 2011 in the Korean Intellectual Property Office and assigned Serial number 10-2011-0134632, a Korean patent application filed on Dec. 28, 2011 in the Korean Intellectual Property Office and assigned Serial number 10-2011-0144091, and a Korean patent application filed on Dec. 28, 2011 in the Korean Intellectual Property Office and assigned Serial number 10-2011-0144276, the entire disclosure of each of which is hereby incorporated by reference.

### TECHNICAL FIELD

The present disclosure relates to an apparatus and a method for providing multiplay electronic book contents in an electronic book system. More particularly, the present disclosure relates to an apparatus and a method for providing dynamic summing-up electronic book contents in an electronic book system. Furthermore, the present disclosure relates to an apparatus and a method for providing advertisement in an electronic book system.

### BACKGROUND

Electronic devices such as a smart phone, a tablet personal computer, and the like have been rapidly developed in various forms. With the rapid development of the various electronic devices, a market for an electronic book also is rapidly developing.

Hereinafter, a process of providing electronic book contents in an electronic book system of the related art will be described with reference to FIG. 1.

FIG. 1 is a view schematically illustrating a process of providing electronic book contents in an electronic book system according to the related art.

Referring to FIG. 1, firstly, an electronic book content server 110 manages a plurality of electronic book contents. A client 120 transmits a message for requesting to buy an electronic book to the electronic book content server 110 in operation 111, and the electronic book content server 110 provides corresponding electronic book contents to the client 120 in response to the request in operation 113.

In the electronic book system implemented as shown in FIG. 1, a user of the client cannot help buying all corresponding electronic book contents in order to read an electronic book suitable for a level and purpose which a user desires.

However, considering characteristics of electronic book contents in which an amendment and a profiling of the contents are possible, it may be unreasonable to buy all electronic book contents having similar contents. Therefore, a necessity for a scheme of providing the electronic book contents suitable for the purpose and the level of the user by a minimal expense is raised.

Hereinafter, a process of providing electronic book contents in an electronic book system of the related art will be described with reference to FIG. 12.

FIG. 12 is a view schematically illustrating a process of providing electronic book contents in an electronic book system according to the related art.

Referring to FIG. 12, firstly, an electronic book content server 1210 manages a plurality of electronic book contents. A client 2420 transmits a message for requesting to buy an electronic book to the electronic book content server 1210 in operation 1211, and the electronic book content server 1210 provides corresponding electronic book contents to the client 1220 in response to the request in operation 1213.

In the electronic book system implemented as shown in FIG. 12, a user of the client cannot help buying all corresponding electronic book contents in order to read an electronic book suitable for a level and purpose which a user desires. Especially, in a case where an amount of contents which a user desires to read are separately available, the client can only additionally buy the electronic book contents suitable for an amount of contents which the user desires, or read an abstract of the corresponding electronic book contents.

However, considering characteristics of electronic book contents in which an amendment and a profiling of the contents is possible, it may be unreasonable to buy all electronic book contents having similar contents. Therefore, a necessity for a scheme of providing the electronic book contents suitable for the purpose and the level of the user by a minimal expense is raised.

Hereinafter, a process of providing an advertisement in an electronic book system of the related art will be described with reference to FIG. 24.

FIG. 24 is a view schematically illustrating a process of providing the advertisement in an electronic book system according to the related art.

Referring to FIG. 24, firstly, an electronic book content server 2410 manages a plurality of electronic book contents, and provides an advertisement to a client 2420 in an online state of being connected to the client 2420 through the Internet. That is, if the electronic book content server 2410 is not connected to the client 2420 through the Internet, the advertisement is not provided to the client 2420 in operation 2411.

In the electronic book system implemented as shown in FIG. 24, it is possible for the electronic book content server to provide an advertisement to the client only in the online state that the electronic book content server is connected to the client through the Internet. If the client is not connected to the electronic book content server through the Internet, it is not possible to provide the advertisement to the client.

On the other hand, in the electronic book system of the related art, only typical book contents such as a novel are provided. However, an importance of an advertisement to which a real-time interaction function is added while providing various contents such as a magazine and a newspaper is raised.

However, since electronic PUBlication (ePUB) of the International Digital Publishing Forum which is a standard of a current electronic book system does not consider providing of an advertisement at all, the need for an efficient scheme of providing an advertisement in the electronic book system is raised.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method for providing multiplay electronic book contents in an electronic book system.

Another aspect of the present disclosure is to provide an apparatus and a method for providing electronic book contents as multiplay electronic book contents, which are editable in correspondence to needs of a user, in an electronic book system.

Another aspect of the present disclosure is to provide an apparatus and a method for providing dynamic summing-up electronic book contents in an electronic book system.

Another aspect of the present disclosure is to provide an apparatus and a method for providing electronic book contents as dynamic summing-up electronic book contents, which are editable in correspondence to needs of a user, in an electronic book system.

Another aspect of the present disclosure is to provide an apparatus and a method for providing an advertisement in an electronic book system.

Another aspect of the present disclosure is to provide an apparatus and a method for providing an advertisement adaptive to a requirement of an advertisement provider in an electronic book system.

In accordance with an aspect of the present disclosure, a client in an electronic book system is provided. The client includes a receiving unit which receives multi-playable electronic book contents, which are electronic book contents including a multiplay profile and multiplay characteristic information, from an electronic book content server, and a control unit which edits the multi-playable electronic book contents in correspondence to a user profile, so as to create the multiplay electronic book contents, wherein the multiplay profile includes at least one multiplay parameter which is characteristic information of corresponding electronic book contents, the multiplay characteristic information indicates information tagging a multiplay parameter which sub-contents which the multi-playable electronic book contents include correspond to among at least one multiplay parameter respectively, and the user profile includes at least one user parameter which is characteristic information of the electronic book contents with which the client intends to be provided.

In accordance with another aspect of the present disclosure, an electronic book content server in an electronic book system is provided. The electronic book content server includes a transmitting unit which provides multi-playable electronic book contents, which are electronic book contents including a multiplay profile and multiplay characteristic information, to a client, wherein the multiplay profile includes at least one multiplay parameter which is characteristic information of corresponding electronic book contents, the multiplay characteristic information indicates information tagging a multiplay parameter which sub-contents which the multi-playable electronic book contents include correspond to among at least one multiplay parameter respectively, and the user profile includes at least one user parameter which is characteristic information of the electronic book contents with which the client intends to be provided.

In accordance with still another aspect of the present disclosure, a client in an electronic book system is provided. The client includes a receiving unit which receives multiplay electronic book contents from an electronic book content server, wherein the multiplay electronic book contents are created by editing multi-playable electronic book contents, which are electronic book contents including a multiplay profile and multiplay characteristic information, in correspondence to a user profile, and wherein the multiplay profile includes at least one multiplay parameter which is characteristic information of corresponding electronic book contents, the multiplay characteristic information indicates information tagging whether sub-contents which the multi-playable electronic book contents include correspond to at least one multiplay parameter respectively, and the user profile includes at least one user parameter which is characteristic information of the electronic book contents with which the client intends to be provided.

In accordance with still another aspect of the present disclosure, an electronic book content server in an electronic book system is provided. The electronic book content server includes a control unit which creates multiplay electronic book contents by editing multi-playable electronic book contents, which are electronic book contents including a multiplay profile and multiplay characteristic information, in correspondence to a user profile, and a transmitting unit which provides the multiplay electronic book contents to the client, wherein the multiplay profile includes at least one multiplay parameter which is characteristic information of corresponding electronic book contents, the multiplay characteristic information indicates information tagging whether sub-contents which the multi-playable electronic book contents include correspond to at least one multiplay parameter respectively, and the user profile includes at least one user parameter which is characteristic information of the electronic book contents with which the client intends to be provided.

In accordance with still another aspect of the present disclosure, a method of providing multiplay electronic book contents of a client in an electronic book system is provided. The method includes receiving multi-playable electronic book contents, which are electronic book contents including a multiplay profile and multiplay characteristic information, from an electronic book content server, and editing the multi-playable electronic book contents in correspondence to a user profile, so as to create the multiplay electronic book contents, wherein the multiplay profile includes at least one multiplay parameter which is characteristic information of corresponding electronic book contents, the multiplay characteristic information indicates information tagging whether sub-contents which the multi-playable electronic book contents include correspond to at least one multiplay parameter respectively, and the user profile includes at least one user parameter which is characteristic information of the electronic book contents with which the client intends to be provided.

In accordance with still another aspect of the present disclosure, a method of providing multiplay electronic book contents of an electronic book content server in an electronic book system is provided. The method includes providing multi-playable electronic book contents, which are electronic book contents including a multiplay profile and multiplay characteristic information, to a client, wherein the multiplay profile includes at least one multiplay parameter which is characteristic information of corresponding electronic book contents, the multiplay characteristic information indicates information tagging whether sub-contents which the multi-playable electronic book contents include correspond to at least one multiplay parameter respectively, and the user profile includes at least one user parameter which is characteristic information of the electronic book contents with which the client intends to be provided.

In accordance with still another aspect of the present disclosure, a method of providing multiplay electronic book contents of a client in an electronic book system is provided. The method includes receiving multiplay electronic book contents from an electronic book content server, wherein the multiplay electronic book contents are created by editing multi-playable electronic book contents, which are electronic book contents including a multiplay profile and multiplay characteristic information, in correspondence to a user profile, and wherein the multiplay profile includes at least one multiplay parameter which is characteristic information of corresponding electronic book contents, the multiplay characteristic information indicates information tagging whether sub-contents which the multi-playable electronic book contents include correspond to at least one multiplay parameter respectively, and the user profile includes at least one user parameter which is characteristic information of the electronic book contents with which the client intends to be provided.

In accordance with still another aspect of the present disclosure, a method of providing multiplay electronic book contents of an electronic book content server in an electronic book system is provided. The method includes creating multiplay electronic book contents by editing multi-playable electronic book contents, which are electronic book contents including a multiplay profile and multiplay characteristic information, in correspondence to a user profile, and providing the multiplay electronic book contents to the client, wherein the multiplay profile includes at least one multiplay parameter which is characteristic information of corresponding electronic book contents, the multiplay characteristic information indicates information tagging whether sub-contents which the multi-playable electronic book contents include correspond to at least one multiplay parameter respectively, and the user profile includes at least one user parameter which is characteristic information of the electronic book contents with which the client intends to be provided.

In accordance with still another aspect of the present disclosure, a client in an electronic book system is provided. The client includes a receiving unit which receives dynamic-summable electronic book contents, which are electronic book contents including a dynamic summing-up profile and dynamic summing-up characteristic information, from an electronic book content server, and a control unit which edits the dynamic-summable electronic book contents in correspondence to a user profile, so as to create the dynamic summing-up electronic book contents, wherein the dynamic summing-up profile includes at least one dynamic summing-up parameter which is characteristic information of corresponding electronic book contents, the dynamic summing-up characteristic information indicates configuration information of each of objects which the dynamic-summable electronic contents include, and the user profile includes at least one user parameter which is characteristic information of electronic book contents with which the client intends to be provided.

In accordance with still another aspect of the present disclosure, an electronic book content server in an electronic book system is provided. The electronic book content server includes providing dynamic-summable electronic book contents, which are electronic book contents including a dynamic summing-up profile and dynamic summing-up characteristic information, to a client, wherein the dynamic summing-up profile includes at least one dynamic summing-up parameter which is characteristic information of corresponding electronic book contents, the dynamic summing-up characteristic information indicates configuration information of each of objects which the dynamic-summable electronic book contents include, and the user profile includes at least one user parameter which is characteristic information of electronic book contents with which the client intends to be provided.

In accordance with still another aspect of the present disclosure, a client in an electronic book system is provided. The client includes a receiving unit receiving dynamic summing-up electronic book contents from an electronic book content server, wherein the dynamic summing-up electronic book contents are created by editing dynamic-summable electronic book contents, which are electronic book contents including a dynamic summing-up profile and dynamic summing-up characteristic information, in correspondence to a user profile, and wherein the dynamic summing-up profile includes at least one dynamic summing-up parameter which is characteristic information of corresponding electronic book contents, the dynamic summing-up characteristic information indicates configuration information of each of objects which the dynamic-summable electronic book contents include, and the user profile includes at least one user parameter which is characteristic information of electronic book contents with which the client intends to be provided.

In accordance with still another aspect of the present disclosure, an electronic book content server in an electronic book system is provided. The electronic book content server includes a control unit which creates dynamic summing-up electronic book contents by editing the dynamic-summable electronic book contents, which are electronic book contents including a dynamic summing-up profile and dynamic summing-up characteristic information, in correspondence to a user profile, and a transmitting unit which provides the dynamic summing-up electronic book contents to the client, wherein the dynamic summing-up profile includes at least one dynamic summing-up parameter which is characteristic information of corresponding electronic book contents, the dynamic summing-up characteristic information indicates configuration information of each of objects which the dynamic-summable electronic book contents include, and the user profile includes at least one user parameter which is characteristic information of electronic book contents with which the client intends to be provided.

In accordance with still another aspect of the present disclosure, a method of providing dynamic summing-up electronic book contents of a client in an electronic book system is provided. The method includes receiving dynamic-summable electronic book contents, which are electronic book contents including a dynamic summing-up profile and dynamic summing-up characteristic information, from an electronic book content server, and editing the dynamic-summable electronic book contents in correspondence to a user profile, so as to create the dynamic summing-up electronic book contents, wherein the dynamic summing-up profile includes at least one dynamic summing-up parameter which is characteristic information of corresponding electronic book contents, the dynamic summing-up characteristic information indicates configuration information of each of objects which the dynamic-summable electronic contents include, and the user profile includes at least one user parameter which is characteristic information of electronic book contents with which the client intends to be provided.

In accordance with still another aspect of the present disclosure, a method of providing dynamic summing-up electronic book contents of an electronic book content server in an electronic book system is provided. The method includes providing dynamic-summable electronic book contents, which are electronic book contents including a dynamic summing-up profile and dynamic summing-up characteristic information, to a client, wherein the dynamic summing-up profile includes at least one dynamic summing-up parameter which is characteristic information of corresponding electronic book contents, the dynamic summing-up characteristic information indicates configuration information of each of objects which the dynamic-summable electronic book contents include, and the user profile includes at least one user parameter which is characteristic information of electronic book contents with which the client intends to be provided.

In accordance with still another aspect of the present disclosure, a method of dynamic summing-up electronic book contents of a client in an electronic book system is provided. The method includes receiving dynamic summing-up electronic book contents from an electronic book content server, wherein the dynamic summing-up electronic book contents are created by editing dynamic-summable electronic book contents, which are electronic book contents including a dynamic summing-up profile and dynamic summing-up characteristic information, in correspondence to a user profile, and wherein the dynamic summing-up profile includes at least one dynamic summing-up parameter which is characteristic information of corresponding electronic book contents, the dynamic summing-up characteristic information indicates configuration information of each of objects which the dynamic-summable electronic book contents include, and the user profile includes at least one user parameter which is characteristic information of electronic book contents with which the client intends to be provided.

In accordance with still another aspect of the present disclosure, a method of providing dynamic summing-up electronic book contents of an electronic book content server in an electronic book system is provided. The method includes creating the dynamic summing-up electronic book contents by editing dynamic-summable electronic book contents, which are electronic book contents including a dynamic summing-up profile and dynamic summing-up characteristic information, in correspondence to a user profile, and providing the dynamic summing-up electronic book contents to the client, wherein the dynamic summing-up profile includes at least one dynamic summing-up parameter which is characteristic information of corresponding electronic book contents, the dynamic summing-up characteristic information indicates configuration information of each of objects which the dynamic-summable electronic book contents include, and the user profile includes at least one user parameter which is characteristic information of electronic book contents with which the client intends to be provided.

In accordance with still another aspect of the present disclosure, a client in an electronic book system is provided. The client includes a receiving unit which receives advertisement electronic book contents, which includes a manifest file having configuration parameters related to an advertisement inserted in corresponding advertisement electronic book contents, from an advertisement electronic book content server, and which receives a non-clickable style of an advertisement object from the advertisement electronic book content server, a control unit which analyzes the manifest file, and a transmitting unit which transmits a message for requesting the non-clickable style of the advertisement object to the advertisement electronic book content server.

In accordance with still another aspect of the present disclosure, an advertisement electronic book content server in an electronic book system is provided. The advertisement electronic book content server includes a transmitting unit which provides advertisement electronic book contents, which includes a manifest file having configuration parameters related to an advertisement inserted in corresponding advertisement electronic book contents, to a client, and which provides a non-clickable style of an advertisement object to the client, and a receiving unit which receives a message for requesting the non-clickable style of the advertisement object from the client.

In accordance with still another aspect of the present disclosure, a client in an electronic book system is provided. The client includes a transmitting unit, a receiving unit, and a control unit, wherein the receiving unit receives advertisement electronic book contents, which includes a manifest file having configuration parameters related to an advertisement inserted in corresponding advertisement electronic book contents, from an advertisement electronic book content server, the control unit analyzes the manifest file, the transmitting unit transmits a message for requesting a click and response style of an advertisement object to the advertisement electronic book content server, the receiving unit receives the click and response style of the advertisement object from the advertisement electronic book content server, the transmitting unit transmits a message for requesting an offer list which is a list of all elements which a succeeding offer includes, to the advertisement electronic book content server, the receiving unit receives the offer list from the advertisement electronic book content server, the transmitting unit transmits a message for requesting all offer elements which the succeeding offer includes, to the advertisement electronic book content server, and the receiving unit receives all elements, which the succeeding offer includes, from the advertisement electronic book content server.

In accordance with still another aspect of the present disclosure, an advertisement electronic book content server in an electronic book system is provided. The advertisement electronic book content server includes a transmitting unit, a receiving unit, and a control unit, wherein the transmitting unit provides advertisement electronic book contents, which includes a manifest file having configuration parameters related to an advertisement inserted in corresponding advertisement electronic book contents, to a client, the receiving unit receives a message for requesting a click and response style of an advertisement object from the client, the transmitting unit provides the click and response style of an advertisement object to the client, the receiving unit receives a message for requesting an offer list which is a list of all elements which a succeeding offer includes, from the client, the transmitting unit provides the offer list to the client, the receiving unit receives a message for requesting all offer elements, which the succeeding offer includes, from the client, and the transmitting unit provides all offer elements, which the succeeding offer includes, to the client.

In accordance with still another aspect of the present disclosure, a client in an electronic book system is provided. The client includes a transmitting unit, a control unit, a receiving unit, and an outputting unit, wherein the receiving unit receives advertisement electronic book contents, which includes a manifest file having configuration parameters related to an advertisement inserted in corresponding advertisement electronic book contents, from an advertisement electronic book content server, the transmitting unit transmits a message for requesting a click-only style of the advertisement object to the advertisement electronic book content server after analyzing the manifest file, the receiving unit receives the click-only style of the advertisement object from the advertisement electronic book content server, the outputting unit outputs the click-only style of the advertisement object, and the transmitting unit transmits a message including a result of an event for the click-only style of the output advertisement object to the advertisement electronic book content server.

In accordance with still aspect of the present disclosure, an advertisement electronic book content server in an electronic book system is provided. The advertisement electronic book content server includes a transmitting unit, a receiving unit, and, a control unit, wherein the transmitting unit provides advertisement electronic book contents, which includes a manifest file having configuration parameters related to an advertisement inserted in corresponding advertisement electronic book contents, to a client, the receiving unit receives a message for requesting a click-only style of an advertisement object from the client, the transmitting unit provides the click-only style of the advertisement object to the client, and the receiving unit receives a message including a result of an event for the click-only style of the advertisement object from the client.

In accordance with still another aspect of the present disclosure, a method of providing an advertisement of a client in an electronic book system is provided. The method includes receiving advertisement electronic book contents, which includes a manifest file having configuration parameters related to an advertisement inserted in corresponding advertisement electronic book contents, from an advertisement electronic book content server, transmitting a message for requesting a non-clickable style of an advertisement object to the advertisement electronic book content server after analyzing the manifest file, and, having a non-clickable style of the advertisement object provided from the advertisement electronic book content server.

In accordance with still another aspect of the present disclosure, a method of providing an advertisement of an advertisement electronic book content server in an electronic book system is provided. The method includes providing advertisement electronic book contents, which includes a manifest file having configuration parameters related to an advertisement inserted in corresponding advertisement electronic book contents, to a client, and, receiving a message for requesting a non-clickable style of advertisement object from the client, and providing a non-clickable style of the advertisement object to the client.

In accordance with still another aspect of the present disclosure, a method of providing an advertisement of a client in an electronic book system is provided. The method includes receiving advertisement electronic book contents, which includes a manifest file having configuration parameters related to an advertisement inserted in corresponding advertisement electronic book contents, from an advertisement electronic book content server, transmitting a message for requesting a click and response style of an advertisement object to the advertisement electronic book content server after analyzing the manifest file, receiving the click and response style of the advertisement object from the advertisement electronic book content server, transmitting a message for requesting an offer list which is a list of all elements which a succeeding offer includes, to the advertisement electronic book content server, receiving the offer list from the advertisement electronic book content server, transmitting a message for requesting all offer elements which the succeeding offer includes, to the advertisement electronic book content server, and, receiving all offer elements, which the succeeding offer includes, from the advertisement electronic book content server.

In accordance with still another aspect of the present disclosure, a method of providing an advertisement of an advertisement electronic book content server in an electronic book system is provided. The method includes providing advertisement electronic book contents, which includes a manifest file having configuration parameters related to an advertisement inserted in corresponding advertisement electronic book contents, to a client, receiving a message for requesting a click and response style of an advertisement object from the client, providing the click and response style of an advertisement object to the client, receiving a message for requesting an offer list which is a list of all elements which a succeeding offer includes, from the client, providing the offer list to the client, receiving a message for requesting all elements, which the succeeding offer includes, from the client, and, providing all offer elements, which the succeeding offer includes, to the client.

In accordance with still another aspect of the present disclosure, a method of providing an advertisement of a client in an electronic book system is provided. The method includes receiving advertisement electronic book contents, which includes a manifest file having configuration parameters related to an advertisement inserted in corresponding advertisement electronic book contents, from an advertisement electronic book content server, transmitting a message for requesting a click-only style of the advertisement object to the advertisement electronic book content server after analyzing the manifest file, receiving the click-only style of the advertisement object from the advertisement electronic book content server, outputting the click-only style of the advertisement object, and, transmitting a message including a result of an event for the click-only style of the output advertisement object to the advertisement electronic book content server.

In accordance with still another aspect of the present disclosure, a method of providing an advertisement of an advertisement electronic book content server in an electronic book system is provided. The method includes providing advertisement electronic book contents, which includes a manifest file having configuration parameters related to an advertisement inserted in corresponding advertisement electronic book contents, to a client, receiving a message for requesting a click-only style of advertisement object from the client, providing the click-only style of the advertisement object to the client, and, receiving a message including a result of an event for the click-only style of the advertisement object from the client.

### Advantageous Effectiveness

The present disclosure has an advantage in providing electronic book contents as multiplay electronic book contents, which are editable in correspondence to needs of a user, in an electronic book system. Since it is possible to provide electronic contents, i.e., multiplay electronic book contents, satisfying the needs of the user as described above, there is an advantage in that satisfaction of the user can be maximized.

The present disclosure has an advantage in providing electronic book contents as dynamic summing-up electronic book contents, which are editable in correspondence to needs of a user, in an electronic book system. Since it is possible to provide the electronic contents, i.e., the dynamic summing-up electronic book contents, satisfying the needs of the user as described above, there is an advantage in that satisfaction of the user can be maximized.

The present disclosure has an advantage in providing the advertisement in the electronic book system. Especially, the present disclosure has an advantage in providing the advertisement adaptive to the needs of the advertisement provider in the electronic book system. Since it is possible to provide the advertisement in the electronic book system as described above, there is an advantage in using the electronic book system in various businesses.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view schematically illustrating a process of providing electronic book contents in an electronic book system according to the related art.

FIG. 2 is a view schematically illustrating a configuration of a client based electronic book system according to a first embodiment of the present disclosure.

FIG. 3 is a signal flow diagram illustrating a process of providing multiplay electronic book contents in the client based electronic book system according to the first embodiment of the present disclosure.

FIG. 4 is a flowchart illustrating an operating process in a client 310 of FIG. 3 according to an embodiment of the present disclosure.

FIG. 5 is a flowchart illustrating an operating process in an electronic book content server 320 of FIG. 3 according to an embodiment of the present disclosure.

FIG. 6 is a view schematically illustrating a configuration of a server based electronic book system according to a second embodiment of the present disclosure.

FIG. 7 is a signal flow diagram illustrating a process of providing multiplay electronic book contents in the server based electronic book system according to the second embodiment of the present disclosure.

FIG. 8 is a flowchart illustrating an operating process in a client 710 of FIG. 7 according to an embodiment of the present disclosure.

FIG. 9 is a flowchart illustrating an operating process in an electronic book content server 720 of FIG. 7 according to an embodiment of the present disclosure.

FIG. 10 is a view schematically illustrating an internal configuration of a client in an electronic book system according to an embodiment of the present disclosure.

FIG. 11 is a view schematically illustrating an internal configuration of an electronic book content server in an electronic book system according to an embodiment of the present disclosure.

FIG. 12 is a view schematically illustrating a process of providing electronic book contents in an electronic book system according to the related art.

FIG. 13 is a view schematically illustrating a tree structure of dynamic summing-up electronic book contents in an electronic book system according to an embodiment of the present disclosure.

FIG. 14 is a view schematically illustrating a configuration of the client based electronic book system according to the first embodiment of the present disclosure.

FIG. 15 is a signal flow diagram illustrating a process of providing dynamic summing-up electronic book contents in the client based electronic book system according to the first embodiment of the present disclosure.

FIG. 16 is a flowchart illustrating an operating process in a client 1510 of FIG. 15 according to an embodiment of the present disclosure.

FIG. 17 is a flowchart illustrating an operating process of an electronic book content server 1520 of FIG. 15 according to an embodiment of the present disclosure.

FIG. 18 is a view schematically illustrating a configuration of a server based electronic book system according to the second embodiment of the present disclosure.

FIG. 19 is a signal flow diagram illustrating a process of providing dynamic summing-up electronic book contents in the server based electronic book system according to the second embodiment of the present disclosure.

FIG. 20 is a flowchart illustrating an operating process in a client 1910 of FIG. 19 according to an embodiment of the present disclosure.

FIG. 21 is a flowchart illustrating an operating process of an electronic book content server 1920 of FIG. 19 according to an embodiment of the present disclosure.

FIG. 22 is a view schematically illustrating an internal configuration of a client in an electronic book system according to an embodiment of the present disclosure.

FIG. 23 is a view schematically illustrating an internal configuration of an electronic book content server in an electronic book system according to an embodiment of the present disclosure.

FIG. 24 is a view schematically illustrating a process of providing the advertisement in an electronic book system according to the related art.

FIG. 25 is a view schematically illustrating a configuration of the electronic book system for providing an advertisement in a non-clickable manner according to the first embodiment of the present disclosure.

FIG. 26 is a signal flow diagram illustrating a process of providing an advertisement in a non-clickable manner in the electronic book system according to the first embodiment of the present disclosure.

FIG. 27 is a flowchart illustrating an operating process in a client 2620 of FIG. 26 according to an embodiment of the present disclosure.

FIG. 28 is a flowchart illustrating an operating process of an electronic book content server 2610 of FIG. 3 according to an embodiment of the present disclosure.

FIG. 29 is a view schematically illustrating a configuration of the electronic book system for providing an advertisement in a click and response manner according to the second embodiment of the present disclosure.

FIG. 30 is a signal flow diagram illustrating a process of providing an advertisement in a click and response manner in the electronic book system according to the second embodiment of the present disclosure.

FIG. 31 is a flowchart illustrating an operating process in a client 3020 of FIG. 30 according to an embodiment of the present disclosure.

FIG. 32 is a flowchart illustrating an operating process of an electronic book content server 3010 of FIG. 30 according to an embodiment of the present disclosure.

FIG. 33 is a view schematically illustrating a configuration of an electronic book system for providing an advertisement in a click only manner according to a third embodiment of the present disclosure.

FIG. 34 is a signal flow diagram illustrating a process of providing an advertisement in a click only manner in the electronic book system according to the third embodiment of the present disclosure.

FIG. 35 is a flowchart illustrating an operating process in a client 3420 of FIG. 34 according to an embodiment of the present disclosure.

FIG. 36 is a flowchart illustrating an operating process of an advertisement electronic book content server 3410 of FIG. 34 according to an embodiment of the present disclosure.

FIG. 37 is a view schematically illustrating an internal configuration of a client in an electronic book system according to an embodiment of the present disclosure.

FIG. 38 is a view schematically illustrating an internal configuration of an advertisement electronic book content server in an electronic book system according to an embodiment of the present disclosure.

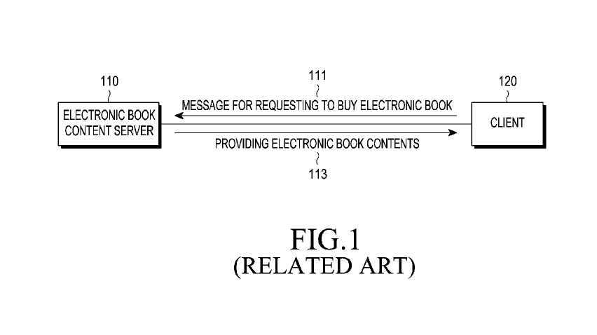

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure proposes an apparatus and a method for providing multiplay electronic book content in an electronic book system.

The present disclosure proposes an apparatus and a method of providing multiplay electronic book contents, which are editable in correspondence to needs of a user, in an electronic book system.

Hereinafter, terms in the description of the present disclosure will be defined as follows:

### (1) Normal Electronic Book Contents

Normal electronic book contents are general electronic book contents, which are identical to electronic book contents provided in an electronic book system according to the related art.

### (2) Multi-Playable Electronic Contents

Multi-playable electronic contents are electronic book contents, which include a multiplay profile editable in correspondence to needs of a user differently from the normal electronic book contents, and multiplay characteristic information. Herein, the multi-playable electronic book contents may be created by editing the normal electronic book contents in correspondence to a multiplay profile and multiplay characteristic information, or may be created to include the multiplay profile and the multiplay characteristic information independently from the normal electronic book contents. Hereinafter, in the present disclosure, for the convenience, it is assumed that the multi-playable electronic book contents are created independently from the normal electronic book contents.

### (3) Multiplay Profile

The multiplay profile may include a multiplay parameter which is characteristic information of electronic book contents, such as a capacity of contents, a field of interest, a view point of reading, a purpose of reading, a level of a reader, an age of a reader, and the like, provided by the multi-playable electronic book contents, and the number of the parameters which the multi-play profile includes is not limited.

### (4) Multi-Play Characteristic Information

The multi-play characteristic information corresponds to information for tagging a multi-play parameter which sub-contents belonging to corresponding multi-playable electronic book contents correspond to among a plurality of multi-play parameters belonging to the multi-play profile.

### (5) User Profile

A user profile may include characteristic information of the electronic contents, i.e., various user parameters, such as a capacity of contents, a field of interest, a view point of reading, a purpose of reading, a level of a reader, an age of a reader, and the like, with which a client intends to be provided. The number of the user parameters which the user profile includes is not limited.

### (6) Multi-Playable Electronic Book Content Flag

A multi-playable electronic book content flag is a flag indicating whether a client intends to be provided with the multi-playable electronic book contents. For example, the multi-playable electronic book content flag may be implemented by 1 bit. For example, when a value of the multi-playable electronic book content flag is ‘1’, the flag indicates that the client intends to be provided with the multi-playable electronic book contents. On the contrary, if a value of the multi-playable electronic book content flag is ‘0’, the flag indicates that the client does not intend to be provided with the multi-playable electronic book contents, i.e., it indicates that the client intends to be provided with the normal electronic book contents.

### (7) Multiplay Electronic Book Content Flag

A multiplay electronic book content flag is a flag indicating whether the client intends to be provided with the multiplay electronic book contents. For example, the multiplay electronic book content flag may be implemented by 1 bit. For example, if a value of the multiplay electronic book content flag is ‘1’, the flag indicates that the client intends to be provided with the multiplay electronic book contents. On the contrary, if a value of the multiplay electronic book content flag is ‘0’, the flag indicates that the client does not intend to be provided with the multiplay electronic book contents, i.e., it indicates that the client intends to be provided with the normal electronic book contents.

On the other hand, in the electronic book system according to the first embodiment of the present disclosure, the multiplay electronic book contents is provided in a client based manner, while in an electronic book system according to the second embodiment of the present disclosure the multiplay electronic book content is provided in a server based manner.

This will be described in detail as follows.

Firstly, in the electronic book system according to the first embodiment of the present disclosure, the client is provided with the multi-playable electronic book contents from the server, and edits the multi-playable electronic book contents by using a multiplay profile, multiplay characteristic information, and a user profile included in the multi-playable electronic book contents so as to provide the multiplay electronic book contents corresponding to needs of a user using the client.

Secondly, in the electronic book system according to the second embodiment of the present disclosure, the server receives a user profile from the client, and edits the multi-playable electronic book contents by using the received user profile, the multiplay profile, and the multiplay characteristic information, so as to provide the multiplay contents corresponding to needs of the user using the client.

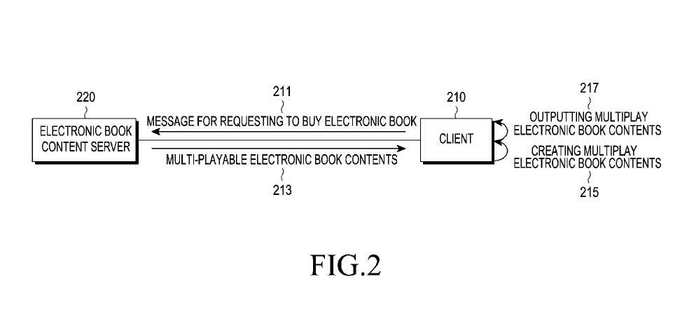

Hereinafter, a configuration of a client based electronic book system according to the first embodiment of the present disclosure will be described with reference to FIG. 2.

FIG. 2 is a view schematically illustrating a configuration of the client based electronic book system according to the first embodiment of the present disclosure.

Referring to FIG. 2, the client based electronic book system includes a client 210 and an electronic book content server 220. The electronic book content server 220 manages a plurality of multi-playable electronic book contents and normal electronic book contents, and provides the multi-playable electronic book contents or the normal electronic book contents to the client 210 in correspondence to the multi-playable electronic book content flag included in a message for requesting to buy the electronic book in operation 213 when receiving the message for requesting to buy the electronic book from the client 210 in operation 211. Here, the message for requesting to buy the electronic book further includes electronic book content information indicating electronic book contents which the client 210 intends to buy. The electronic book content information may be, for example, an electronic book content index, a title of a book, and the like.

Referring to FIG. 2, for convenience in description, it is assumed that the client 210 intends to be provided with the multi-playable electronic book contents. In this case, the electronic book content server 220 detects corresponding multi-playable electronic book contents among the multi-playable electronic book contents which it manages, and provides the corresponding multi-playable electronic book contents to the client 210. The client 210 which is provided with the multi-playable electronic book contents from the electronic book content server 220, edits the multi-playable electronic book contents to correspond to the user profile which is previously set, so as to create the multiplay electronic book contents in operation 215. The client 210 edits the multi-playable electronic book contents, which are received in correspondence to the user profile, so as to create the multiplay electronic book contents, and outputs the created multiplay electronic book contents in operation 217. Here, the multiplay electronic book contents may be implemented in various forms of images, sounds, and the like. A detailed description of outputting the multiplay electronic book content will be omitted.

Further, the client 210 edits the multi-playable electronic book contents in correspondence to the user profile, and a multiplay profile and multiplay characteristic information included in the multi-playable electronic book contents provided from the server 220, so as to create the multiplay electronic book contents. For example, in the case where the user profile indicates that a capacity of the contents is 800 Mb, that the field of interest is philosophy, that the purpose of reading is learning, and that the reader is of middle school age, and the multiplay profile included in the multi-playable electronic book contents indicates that the capacity of the contents is 1000 Mb, that the field of interest is philosophy and literature, that the purpose of the reading is for learning and a hobby, and that the reader is of middle or high school age, only sub-contents, which correspond to the user profile, are extracted by using the multiplay characteristic information from the sub-contents which the multi-playable electronic book contents include, so as to create the multiplay electronic book contents.

On the other hand, the multi-playable electronic book contents including the multiplay profile and the multiplay characteristic information may be implemented in the form as indicated below in Table 1.

TABLE 1
<HTML><HEAD><TITLE>EPUB Overview</TITLE></HEAD>
<Body><div id=rich, age=10> Need for rich media and interactivity
support. <div id=rich 1, age=40, Level= “mid”> EPUB 2.0.1 has an
extension mechanism, with provision for fallbacks, but does not
intrinsically standardize support for rich media (such as video) and
interactivity (programmatic content, such as would be needed to
implement a quiz or crossword puzzle). </div>........<div id=rich 2,
age=40, Level= “high”> These capabilities are necessary for interactive
digital textbooks and digital magazines, and more generally to enable
eBooks to evolve into a new medium, rather than simply be digital
equivalents of paper books. <div id=rich 3, age=40, Level= “high”> They
can be supported by using HTML 5 or JS and so on.
</div>........</div></div>........<img src= “/epub/image.jpg
age=20></div></Body></HTML>

In Table 1, “age” is a multiplay parameter indicating the age of the reader, and “Level” is a multiplay parameter indicting the level of reading.

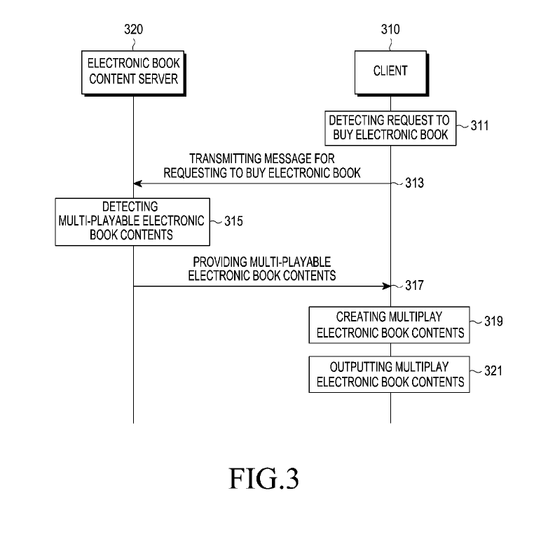

Next, a process of providing the multiplay electronic book contents in the client based electronic book system according to the first embodiment of the present disclosure will be described with reference to FIG. 3.

FIG. 3 is a signal flow diagram illustrating a process of providing multiplay electronic book contents in the client based electronic book system according to the first embodiment of the present disclosure.

Referring to FIG. 3, firstly, when the client 310 detects a request to buy an electronic book in operation 311, it transmits a message for requesting to buy the electronic book to the electronic book content server 320 in operation 313. Here, the message for requesting to buy the electronic book includes a multi-playable electronic book content flag, electronic book content information, and the like. Referring to FIG. 3, it is assumed that the multi-playable electronic book content flag indicates that the client intends to be provided with the multi-playable electronic book contents.

The electronic book content server 320 which receives a message for requesting to buy the electronic book detects a multi-playable electronic book content flag included in the message for requesting to buy the electronic book, and the multi-playable electronic book contents corresponding to the electronic book content information in operation 315. Further, the electronic book content server 320 provides the detected multi-playable electronic book contents to the client 310 in operation 317.

The client 310 edits the multi-playable electronic book contents provided from the electronic book content server 320 in correspondence to the user profile, so as to create the multiplay electronic book contents in operation 319. The client 310 outputs the created multiplay electronic book contents in operation 321.

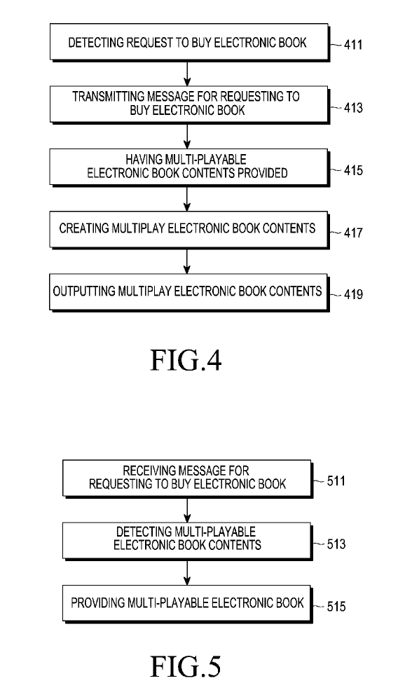

Hereinafter, an operation of the client 310 of FIG. 3 will be described with reference to FIG. 4.

FIG. 4 is a flowchart illustrating an operation of the client 310 of FIG. 3 according to an embodiment of the present disclosure.

Referring to FIG. 4, firstly, the client 310 detects a request to buy the electronic book in operation 411, and it proceeds to operation 413. In operation 413, the client 310 transmits a message for requesting to buy the electronic book to the electronic book content server 320, and it proceeds to operation 415. Here, the message for requesting to buy the electronic book includes the multi-playable electronic book content flag indicating an intention to be provided with the multi-playable electronic book contents, and the electronic book content information, etc. The client 310 is provided with the multi-playable electronic book contents from the electronic book content sever 320 in operation 415, and it proceeds to operation 417. The client 310 edits the multi-playable electronic book contents provided from the electronic book content server 320 in correspondence to the user profile in operation 417, so as to create the multiplay electronic book contents in operation 419. In operation 419, the client 310 outputs the created multiplay electronic book contents.

Hereinafter, an operation of the electronic book content server 320 of FIG. 3 will be described with reference to FIG. 5.

FIG. 5 is a flowchart illustrating an operating of an electronic book content server 320 of FIG. 3 according to an embodiment of the present disclosure.

Referring to FIG. 5, firstly, when the electronic book content server 320 receives the message for requesting to buy the electronic book which includes the multi-playable electronic book content flag indicating an intention to be provided with the multi-play electronic book content, the electronic book content information, and the like, in operation 511, it proceeds to operation 513. In operation 513, the electronic book content server 320 detects the multi-playable electronic book content flag included in the message for requesting to buy the electronic book, and the multi-playable electronic book contents corresponding to the electronic book content information, and then proceeds to operation 515. In operation 515, the electronic book content server 320 provides the detected multi-playable electronic book contents to the client 310.

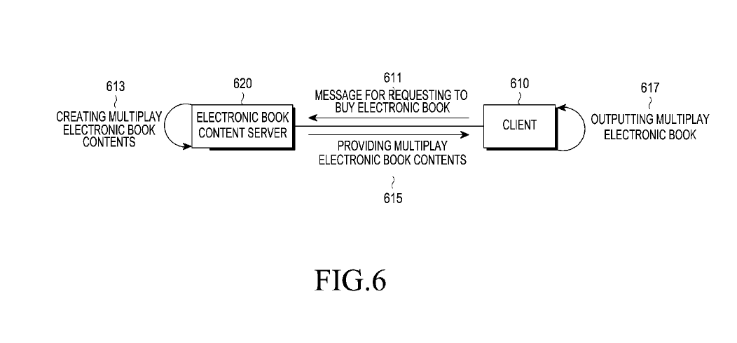

Hereinafter, a configuration of a server based electronic book system according to the second embodiment of the present disclosure will be described with reference to FIG. 6.

FIG. 6 is a view schematically illustrating a configuration of a server based electronic book system according to the second embodiment of the present disclosure.

Referring to FIG. 6, the server based electronic book system includes a client 610 and an electronic book content server 620. The electronic book content server 620 manages a plurality of multi-playable electronic book contents and normal electronic book contents, and provides the multiplay electronic book contents or the normal electronic book contents to the client 610 in correspondence to the multiplay electronic book content flag included in a message for requesting to buy the electronic book in operation 615, when receiving the message for requesting to buy the electronic book from the client 610 in operation 611. Referring to FIG. 6, for convenience in description, it is assumed that the client 610 intends to be provided with the multiplay electronic book contents. As described above, if the client 610 intends to be provided with the multiplay electronic book contents, the message for requesting to buy the electronic book further includes the user profile.

Further, as it is assumed that the client 610 intends to be provided with the multiplay electronic book contents, the electronic book content server 620 detects corresponding multi-playable electronic book contents among the multi-playable electronic book contents, and edits the multi-playable electronic book contents in correspondence to the user profile, so as to create the multiplay electronic book contents in operation 613. The electronic book content server 620 creates the multiplay electronic book contents in the same manner that the client creates the multiplay electronic book contents in the client based electronic book system. Therefore, a detailed description of the creation of the multiplay electronic book contents will be omitted. The electronic book content server 620 provides the created multiplay electronic book contents to the client 610. The client 610 provided with the multiplay electronic book contents from the electronic book content server 620 outputs the provided multiplay electronic book contents in operation 617.

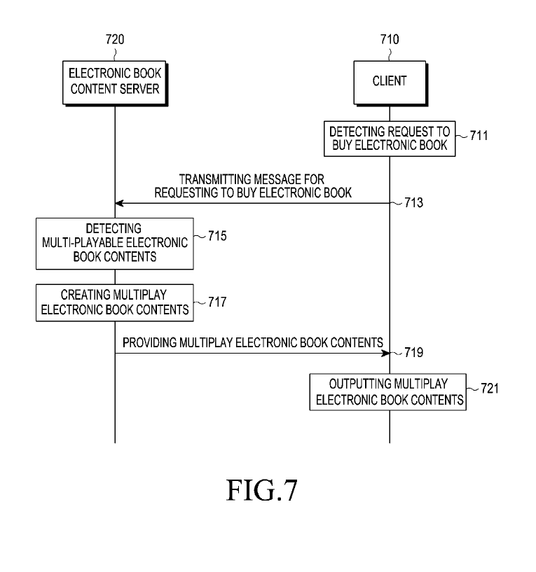

Next, a process of providing the multiplay electronic book contents in the server based electronic book system according to the second embodiment of the present disclosure will be described with reference to FIG. 7.

FIG. 7 is a signal flow diagram illustrating a process of providing multiplay electronic book contents in the server based electronic book system according to the second embodiment of the present disclosure.

Referring to FIG. 7, firstly, when the client 710 detects a request to buy an electronic book in operation 711, it transmits a message for requesting to buy the electronic book to the electronic book content server 720 in operation 713. Here, the message for requesting to buy the electronic book includes a multiplay electronic book content flag, electronic book content information, a user profile, and the like. Referring to FIG. 7, it is assumed that the multiplay electronic book content flag indicates that the client intends to be provided with the multiplay electronic book contents.

The electronic book content server 720 which receives a message for requesting to buy the electronic book detects a multiplay electronic book content flag included in the message for requesting to buy the electronic book, and the multi-playable electronic book contents corresponding to the electronic book content information in operation 715. Further, the electronic book content server 720 edits the detected multi-playable electronic book contents in correspondence to the user profile, so as to create the multiplay electronic book contents in operation 717. The electronic book content server 720 provides the created multiplay electronic book contents to the client 710 in operation 719. The client 710 outputs the multiplay electronic book contents provided from the electronic book content server 720 in operation 721.

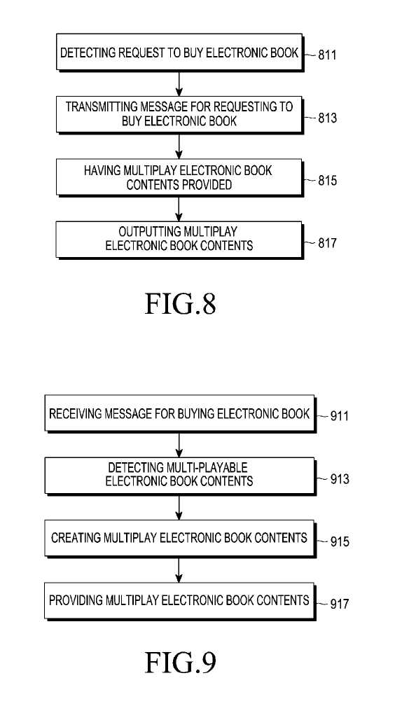

Hereinafter, an operation of the client 710 of FIG. 7 will be described with reference to FIG. 8.

FIG. 8 is a flowchart illustrating an operating process in the client 710 of FIG. 7 according to an embodiment of the present disclosure.

Referring to FIG. 8, firstly, the client 710 detects a request to buy the electronic book in operation 811, and the client 710 proceeds to operation 813. In operation 813, the client 710 transmits a message for requesting to buy the electronic book to the electronic book content server 720, and it proceeds to operation 815. Here, the message for requesting to buy the electronic book includes a multiplay electronic book content flag, electronic book content information, a user profile, and the like.

In operation 815, the client 710 is provided with the multiplay electronic book contents from the electronic book content sever 720, and it proceeds to operation 817. In operation 817, the client 710 outputs the multiplay electronic book contents provided from the electronic book content server 720.

Hereinafter, an operation of the electronic book content server 720 of FIG. 7 will be described with reference to FIG. 9.

FIG. 9 is a flowchart illustrating an operating process in an electronic book content server 720 of FIG. 7 according to an embodiment of the present disclosure.

Referring to FIG. 9, firstly, when the electronic book content server 720 receives the message for requesting to buy the electronic book from the client 710 in operation 911, it proceeds to operation 913. Here, the message for requesting to buy the electronic book includes a multiplay electronic book content flag, electronic book content information, a user profile, and the like. In operation 913, the electronic book content server 720 detects the multiplay electronic book content flag included in the message for requesting to buy the electronic book, and the multi-playable electronic book contents corresponding to the electronic book content information, and then proceeds to operation 915. In operation 915, the electronic book content server 720 edits the detected multi-playable electronic book contents in correspondence to the user profile, so as to create the multiplay electronic book contents, and then proceeds to operation 917. In operation 917, the electronic book content server 720 provides the created multiplay electronic book contents to the client 710.

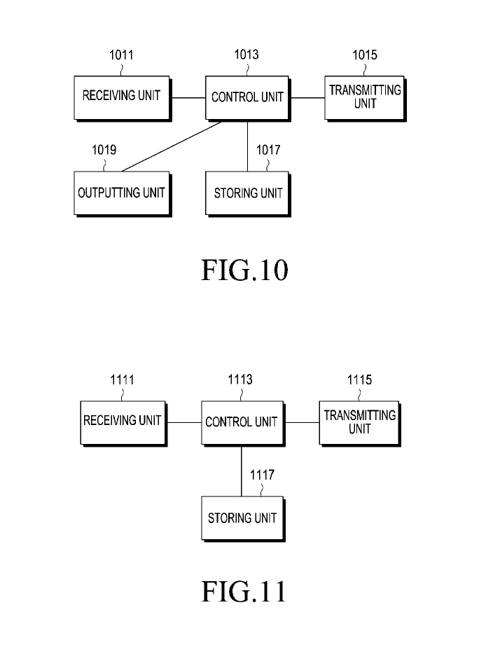

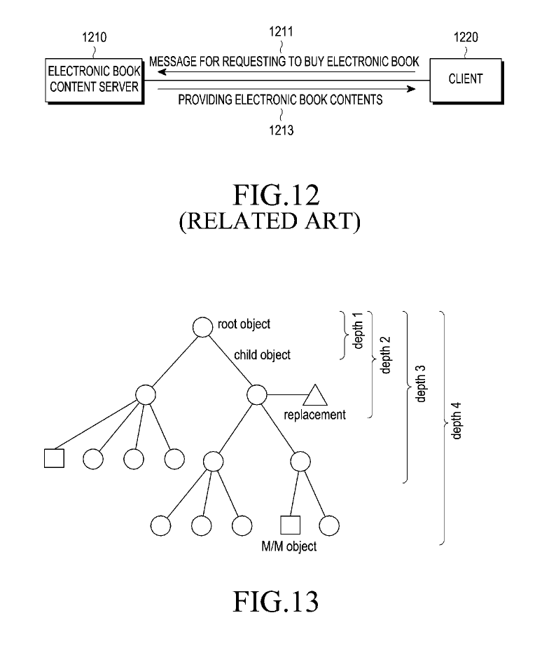

Next, an internal configuration of a client in the electronic book system according to an embodiment of the present disclosure will be described with reference to FIG. 10.

FIG. 10 is a view schematically illustrating the internal configuration of the client in the electronic book system according to an embodiment of the present disclosure.

Referring to FIG. 10, the client includes a receiving unit 1011, a control unit 1013, a transmitting unit 1015, a storing unit 1017, and an outputting unit 1019. The control unit 1013 controls an overall operation of the client, and especially, controls to perform an overall operation related to providing of the multiplay electronic book contents according to the first and second embodiments of the present disclosure. Here, since the overall operation related to the providing of the multiplay electronic book contents is identical to that described with reference to FIGS. 2 to 9, a detailed description of the overall operation related to the providing of the multiplay electronic book contents will be omitted.

The receiving unit 1011 receives various contents and messages from the electronic book server and the like under a control of the control unit 1013. Particularly, in the first embodiment of the present disclosure, the receiving unit 1011 receives the multi-playable electronic book contents from the electronic book server, and in the second embodiment of the present disclosure, the receiving unit 1011 receives the multiplay electronic book contents from the electronic book server. Since the multiplay electronic book contents is received in an identical manner to that described with reference to FIGS. 2 to 9, a detailed description of the reception of the multiplay electronic book contents will be omitted.

The transmitting unit 1015 transmits various contents and messages to the electronic book server and the like under a control of the control unit 1013. Here, a message that the transmitting unit 1015 transmits may be, for example, a message for requesting to buy the electronic book, and the like. The storing unit 1017 stores various contents, various messages, and different kinds of data necessary for the operation of the client, which the receiving unit 1011 receives. The output unit 1019 outputs the multiplay electronic book contents under the control of the control unit 1013, and various output forms of the electronic book contents may be present.

On the other hand, although FIG. 10 shows a case where the receiving unit 1011, the control unit 1013, the transmitting unit 1015, the storing unit 1017, and the output unit 1019 are individually implemented, the receiving unit 1011, the control unit 1013, the transmitting unit 1015, the storing unit 1017, and the output unit 1019 may be implemented as one unit.

Next, an internal configuration of a client in the electronic book system according to an embodiment of the present disclosure will be described with reference to FIG. 11.

FIG. 11 is a view schematically illustrating the internal configuration of the electronic book content server in the electronic book system according to an embodiment of the present disclosure.

Referring to FIG. 11, the electronic book content server includes a receiving unit 1111, a control unit 1113, a transmitting unit 1115, and a storing unit 1117. The control unit 1113 controls an overall operation of the electronic book content server, and especially, controls to perform an overall operation related to providing of the multiplay electronic book contents according to the first and second embodiments of the present disclosure. Here, since the overall operation related to the providing of the multiplay electronic book contents is identical to that described with reference to FIGS. 2 to 9, a detailed description of the overall operation related to the providing of the multiplay electronic book contents will be omitted.

The receiving unit 1111 receives various messages from the client and the like under a control of the control unit 1113. For example, the message received from the client may be a message for requesting to buy the electronic book, and the like. The transmitting unit 1115 transmits various contents and messages to the client and the like under a control of the control unit 1113. Various contents transmitted and provided from the transmitting unit 1115 to the client may be the multi-playable electronic book contents in the first embodiment of the present disclosure, while the various contents may be the multiplay electronic book contents in the second embodiment of the present disclosure. Since the various contents are identical to those described with reference to FIGS. 2 to 9, a detailed description of the various contents will be omitted.

The storing unit 1117 stores a plurality of normal electronic book contents, multi-playable electronic book contents, various contents and messages received by the receiving unit 1111, different kinds of data necessary for an operation of the electronic book content server, and the like.

On the other hand, although FIG. 11 shows a case where the receiving unit 1111, the control unit 1113, the transmitting unit 1115, and the storing unit 1117 are implemented as separate units, the receiving unit 1111, the control unit 1113, the transmitting unit 1115, and the storing unit 1117 may be implemented as one unit.

The present disclosure proposes an apparatus and a method for providing dynamic summing-up electronic book content in the electronic book system.

The present disclosure proposes an apparatus and a method for providing electronic book contents as dynamic summing-up electronic book contents, which is editable in correspondence to needs of a user, in an electronic book system.

Hereinafter, terms in the description of the present disclosure will be defined as follows.

### (1) Normal Electronic Book Contents

Normal electronic book contents are general electronic book contents, which are identical to electronic book contents provided in an electronic book system according to the related art.

### (2) Dynamic-Summable Electronic Book Contents

Dynamic-summable electronic book contents are electronic book contents, which includes a dynamic summing-up profile editable in correspondence to needs of a user differently from the normal electronic book contents, and dynamic summing-up characteristic information. Herein, the dynamic-summable electronic book contents may be created by editing the normal electronic book contents in correspondence to the dynamic summing-up profile and dynamic summing-up characteristic information, or may be created to include the dynamic summing-up profile and the dynamic summing-up characteristic information independently from the normal electronic book contents. Hereinafter, in the present disclosure, for convenience in description, it is assumed that the dynamic summable electronic book contents are created independently from the normal electronic book contents.

### (3) Dynamic Summing-Up Profile

The dynamic summing-up profile may include characteristic information of the electronic book contents provided by the dynamic-summable electronic book contents, for example, a dynamic summing-up parameter which is characteristic information such as a capacity of the contents, and the number of the parameters included in the dynamic summing-up profile is not limited.

### (4) Dynamic Summing-Up Characteristic Information

The dynamic summing-up characteristic information includes configuration information of each of sub-contents, i.e., objects, which dynamic-summable electronic book contents includes, such as depth information, replacement information, exception information, showing information, and the like. In a case where the electronic book contents are implemented in a tree structure, the depth information is information indicating a location which a corresponding object corresponds to in a corresponding tree structure, and the replacement information indicates that an object replaceable for a corresponding object is present. The exception information indicates that the corresponding object is not output only in a case where the corresponding object has specific depth information, and the showing information indicates that the corresponding object is output only in a case where the corresponding object has specific depth information.

Now, the tree structure of the dynamic-summable electronic book contents in the electronic book system according to an embodiment of the present disclosure will be described with reference to FIG. 13.

FIG. 13 is a view schematically illustrating a tree structure of dynamic-summable electronic book content in the electronic book system according to an embodiment of the present disclosure.

Referring to FIG. 13, the dynamic-summable electronic book contents include a plurality of objects, and an object located at the uppermost in the tree structure is referred to as “root object”. Further, objects located below the root object in the tree structure are referred to as “child objects”, respectively. Further, the corresponding objects are classified into depth information, and a specific object is mapped on a replacement object one on one.

### (5) User Profile

A user profile may include various user parameters such as characteristic information of electronic book contents, e.g., a capacity of contents, with which the client intends to be provided, and of course, the number of the user parameters which the user profile includes is not limited.

### (6) Dynamic-Summable Electronic Book Content Flag

A dynamic-summable electronic book content flag is a flag indicating whether the client intends to be provided with the dynamic-summable electronic book contents. For example, the dynamic-summable electronic book content flag may be implemented by 1 bit. For example, when a value of the dynamic-summable electronic book content flag is ‘1’, the flag indicates that the client intends to be provided with the dynamic-summable electronic book contents. On the contrary, if a value of the dynamic-summable electronic book content flag is ‘0’, the flag indicates that the client does not intend to be provided with the dynamic-summable electronic book contents, i.e., it indicates that the client intends to be provided with the normal electronic book contents.

### (7) Dynamic Summing-Up Electronic Book Content Flag

A dynamic summing-up electronic book content flag is a flag indicating whether the client intends to be provided with the dynamic summing-up electronic book contents. For example, the dynamic summing-up electronic book content flag may be implemented by 1 bit. For example, when a value of the dynamic summing-up electronic book content flag is ‘1’, the flag indicates that the client intends to be provided with the dynamic summing-up electronic book contents. On the contrary, if a value of the dynamic summing-up electronic book content flag is ‘0’, the flag indicates that the client does not intend to be provided with the dynamic summing-up electronic book contents, i.e., it indicates that the client intends to be provided with the normal electronic book contents.

On the other hand, in the electronic book system according to the first embodiment of the present disclosure, the dynamic summing-up electronic book contents are provided in a client based manner, while in an electronic book system according to the second embodiment of the present disclosure the dynamic summing-up electronic book contents are provided in a server based manner.

This will be described in detail as follows.

Firstly, in the electronic book system according to the first embodiment of the present disclosure, the client is provided with the dynamic-summable electronic book contents from the server, and edits the dynamic-summable electronic book contents by using a dynamic summing-up profile, dynamic summing-up characteristic information, and a user profile included in the dynamic-summable electronic book contents, so as to provide the dynamic summing-up electronic book contents corresponding to needs of the user using the client.

Secondly, in the electronic book system according to the second embodiment of the present disclosure, the server receives a user profile from the client, and edits the dynamic-summable electronic book contents by using the received user profile, the dynamic-summable profile, and the dynamic summing-up characteristic information, so as to provide the dynamic summing-up contents corresponding to the needs of the user using the client.

Hereinafter, a configuration of a client based electronic book system according to the first embodiment of the present disclosure will be described with reference to FIG. 3.

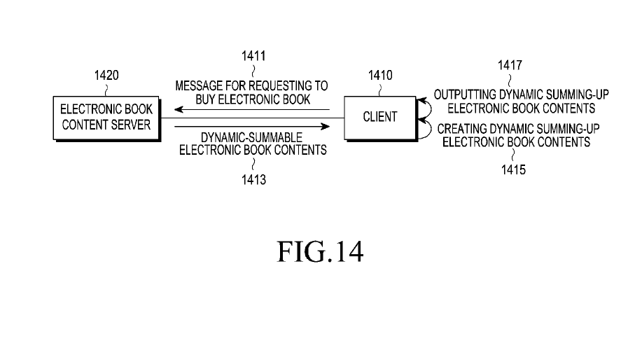

FIG. 14 is a view schematically illustrating a configuration of the client based electronic book system according to the first embodiment of the present disclosure.

Referring to FIG. 14, the client based electronic book system includes a client 1410 and an electronic book content server 1420. The electronic book content server 1420 manages a plurality of dynamic-summable electronic book contents and normal electronic book contents, and provides the dynamic-summable electronic book contents or the normal electronic book contents to the client 1410 in correspondence to the dynamic-summable electronic book content flag included in a message for requesting to buy the electronic book in operation 1413 when receiving the message for requesting to buy the electronic book from the client 1410 in operation 1411. Here, the message for requesting to buy the electronic book further includes electronic book content information indicating electronic book contents which the client 1410 intends to buy. The electronic book content information may be, for example, an electronic book content index, a title of a book, and the like.

Referring to FIG. 14, for convenience in description, it is assumed that the client 1410 intends to be provided with the dynamic-summable electronic book contents. In this case, the electronic book content server 1420 detects corresponding dynamic-summable electronic book contents among the dynamic-summable electronic book contents which it manages, and provides the corresponding dynamic-summable electronic book contents to the client 1410. The client 1410 which is provided with the dynamic-summable electronic book contents from the electronic book content server 1420, edits the dynamic-summable electronic book contents to correspond to the predetermined user profile, so as to create the dynamic summing-up electronic book contents in operation 1415. The client 1410 edits the dynamic-summable electronic book contents, which are received in correspondence to the user' profile, so as to create the dynamic summing-up electronic book contents, and outputs the created dynamic summing-up electronic book contents in operation 1417. Here, the dynamic summing-up electronic book contents may be implemented in various forms of images, sounds, and the like. A detailed description of outputting the dynamic summing-up electronic book contents will be omitted.

Further, the client 1410 edits the dynamic-summable electronic book contents in correspondence to the user profile, and a dynamic summing-up profile and dynamic summing-up characteristic information which are included in the dynamic-summable electronic book contents provided from the server 1420, so as to create the dynamic summing-up electronic book contents. For example, in the case where the user profile indicates that the capacity of the contents is 800 Mb (megabyte), and that the dynamic summing-up profile included in the dynamic-summable electronic book contents indicates that the capacity of the contents is 1000 Mb, only objects corresponding to the user profile are extracted by using the dynamic summing-up characteristic information among the sub-contents which the dynamic-summable electronic book contents include, so as to create the dynamic summing-up electronic book contents.

On the other hand, the dynamic-summable electronic book contents including the dynamic summing-up profile and the dynamic summing-up characteristic information may be implemented in the form as indicated below in Table 2.

```
TABLE 2
            <HTML><HEAD> <TITLE> EPUB Overview
</TITLE></HEAD><Body><div id=rich, depth=1> Need for rich media
and interactivity support. <div id=rich1, depth=2, exception_depth=
“3-10”> EPUB 2.0.1 has an extension mechanism, with provision for
fallbacks, but does not intrinsically standardize support for rich media
(such as video) and interactivity (programmatic content, such as would
be needed to implement a quiz or crossword puzzle). </div>.........<div
id=rich2, depth=2, replacement= “/epub/othertext.html” target=
“4,5”> These capabilities are necessary for interactive digital textbooks
and digital magazines, and more generally to enable eBooks to evolve into
a new medium, rather than simply be digital equivalents of paper books.
<div id=rich3, depth=3, showing_depth= “3”> They
can be supported by using HTML5 or JS and so on.</div>.........</div>
            </div>.........<img src= “/epub/image.jpg depth=2>
</div></Body></HTML>
```

In Table 2, “depth” is dynamic summing-up characteristic information indicating a location in the tree structure of the dynamic-summable electronic book contents, and “exception” is dynamic summing-up characteristic information indicating that a corresponding object is not output only when the object has specific depth information. Further, “showing” is dynamic summing-up characteristic information indicating that a corresponding object is output only when the object has specific depth information.

For example, in Table 2, “<div id=rich1, depth=2, exception depth=”3-10”>EPUB 2.0.1 has an extension mechanism, with provision for fallbacks, but does not intrinsically standardize support for rich media (such as video) and interactivity (programmatic content, such as would be needed to implement a quiz or crossword puzzle). </div>” will be described as follows.

Firstly, “depth=2” indicates that a corresponding object, i.e., “EPUB 2.0.1 has an extension mechanism, with provision for fallbacks, but does not intrinsically standardize support for rich media (such as video) and interactivity (programmatic content, such as would be needed to implement a quiz or crossword puzzle)”, is output when the depth information in the tree structure of corresponding dynamic-summable electronic book contents is two. The exception depth=“3-10” indicates that the corresponding object is not output when the depth information in the tree structure of the corresponding dynamic-summable electronic contents is 3 to 10.

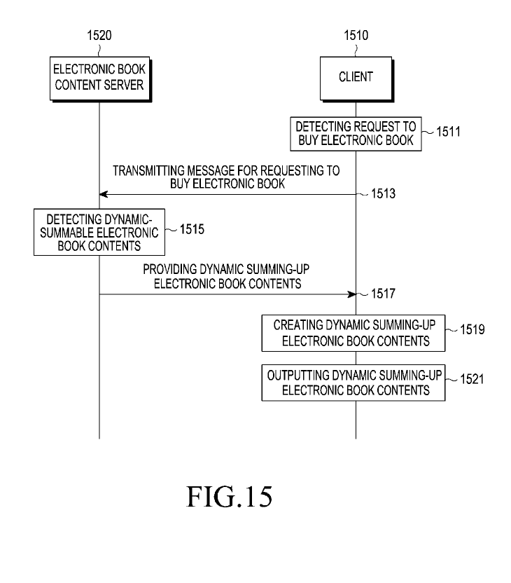

Next, a process of providing the dynamic summing-up electronic book contents in the client based electronic book system according to the first embodiment of the present disclosure will be described with reference to FIG. 15.

FIG. 15 is a signal flow diagram illustrating a process of providing dynamic summing-up electronic book contents in the client based electronic book system according to the first embodiment of the present disclosure.

Referring to FIG. 15, firstly, when the client 1510 detects a request to buy an electronic book in operation 1511, it transmits a message for requesting to buy the electronic book to the electronic book content server 1520 in operation 1513. Here, the message for requesting to buy the electronic book includes a dynamic-summable electronic book content flag, electronic book content information, and the like. Referring to FIG. 15, it is assumed that the dynamic-summable electronic book content flag indicates that the client intends to be provided with the dynamic-summable electronic book contents.

The electronic book content server 1520 which receives a message for requesting to buy the electronic book detects a dynamic-summable electronic book content flag included in the message for requesting to buy the electronic book, and the dynamic-summable electronic book contents corresponding to the electronic book content information in operation 1515. Further, the electronic book content server 1520 provides the detected dynamic-summable electronic book contents to the client 1510 in operation 1517.

The client 1510 edits the dynamic-summable electronic book contents provided from the electronic book content server 1520 in correspondence to the user profile, so as to create the dynamic-summable electronic book contents in operation 1519. The client 1510 outputs the created dynamic-summable electronic book contents in operation 1521.

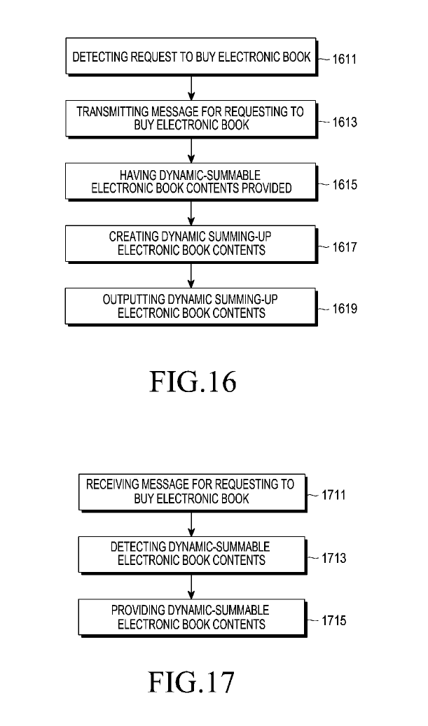

Hereinafter, an operation of the client 1510 of FIG. 15 will be described with reference to FIG. 16.

FIG. 16 is a flowchart illustrating an operating of a client 1610 of FIG. 15 according to an embodiment of the present disclosure.

Referring to FIG. 16, firstly, the client 1510 detects a request to buy the electronic book in operation 1611, and it proceeds to operation 1613. In operation 1613, the client 1510 transmits a message for requesting to buy the electronic book to the electronic book content server 1520, and it proceeds to operation 1615. Here, the message for requesting to buy the electronic book includes the dynamic-summable electronic book content flag indicating that the client 1510 intends to be provided with the dynamic-summable electronic book contents, and the electronic book content information, etc. In operation 1615, the client 1510 is provided with the dynamic-summable electronic book contents from the electronic book content sever 1520, and it proceeds to operation 1617. The client 1510 edits the dynamic-summable electronic book contents provided from the electronic book content server 1520 in correspondence to the user profile, so as to create the dynamic-summable electronic book contents in operation 1617, and it proceeds operation 1619. In operation 1619, the client 1510 outputs the created dynamic-summable electronic book contents.

Hereinafter, an operation of the electronic book content server 1520 of FIG. 15 will be described with reference to FIG. 17.

FIG. 17 is a flowchart illustrating an operating process of an electronic book content server 1520 of FIG. 15 according to an embodiment of the present disclosure.

Referring to FIG. 17, firstly, the electronic book content server 1520 receives a dynamic-summable electronic content flag indicating that the client intends to be provided with the dynamic summing-up electronic book contents, and the message for requesting to buy the electronic book, which includes the electronic book content information, etc., from the client in operation 1711, and it proceeds to operation 1713. In operation 1713, the electronic book content server 1520 detects the dynamic-summable electronic book content flag included in the message for requesting to buy the electronic book, and the dynamic-summable electronic book contents corresponding to the electronic book content information, and it proceeds to operation 1715. In operation 1715, the electronic book content server 1520 provides the detected dynamic-summable electronic book contents to the client 1510.

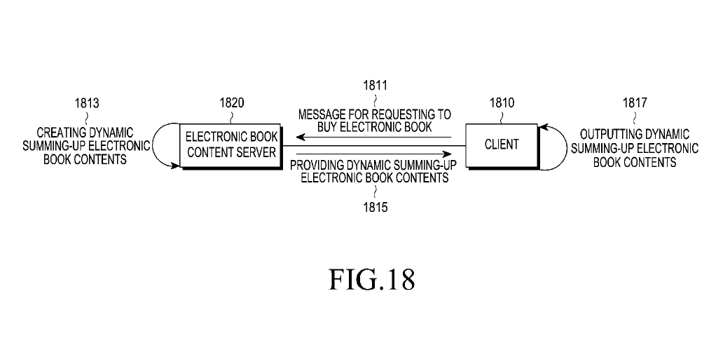

Hereinafter, a configuration of a server based electronic book system according to the second embodiment of the present disclosure will be described with reference to FIG. 18.

FIG. 18 is a view schematically illustrating a configuration of a server based electronic book system according to the second embodiment of the present disclosure.

Referring to FIG. 18, the server based electronic book system includes a client 1810 and an electronic book content server 1820. The electronic book content server 1820 manages a plurality of dynamic-summable electronic book contents and normal electronic book contents, and provides the dynamic summing-up electronic book contents or the normal electronic book contents to the client 1810 in correspondence to the dynamic summing-up electronic book content flag included in a message for requesting to buy the electronic book in operation 1815 when receiving the message for requesting to buy the electronic book from the client 1810 in operation 1811. Referring to FIG. 18, for convenience in description, it is assumed that the client 1810 intends to be provided with the dynamic summing-up electronic book contents. As described above, if the client 1810 intends to be provided with the dynamic summing-up electronic book contents, the message for requesting to buy the electronic book further includes the user's profile.

Further, as it is assumed that the client 1810 intends to be provided with the dynamic summing-up electronic book contents, the electronic book content server 1820 detects corresponding dynamic-summable electronic book contents among the dynamic-summable electronic book contents, and edits the dynamic-summable electronic book contents in correspondence to the user's profile, so as to create the dynamic summing-up electronic book contents in operation 1813. The electronic book content server 1820 creates the dynamic summing-up electronic book content in the same manner as the client creates the dynamic summing-up electronic book contents in the client based electronic book system. Therefore, a detailed description of the creation of the dynamic summing-up electronic book contents will be omitted. The electronic content server 1820 provides the created dynamic summing-up electronic book contents to the client 1810. The client 1810 provided with the dynamic summing-up electronic book contents from the electronic book content server 1820 outputs the provided dynamic summing-up electronic book contents in operation 1817.

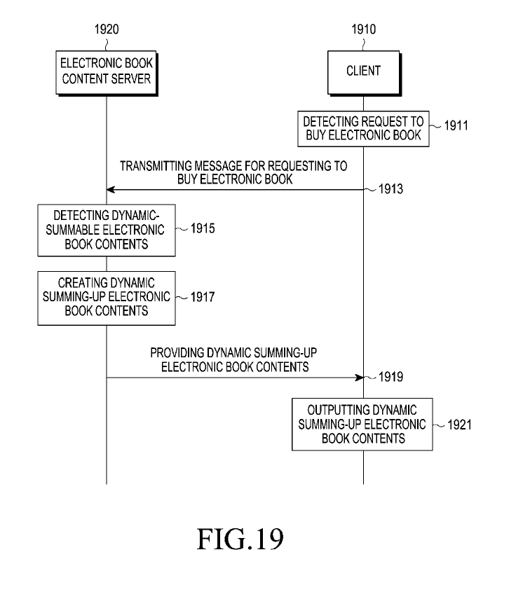

Next, a process of providing the dynamic summing-up electronic book contents in the server based electronic book system according to the second embodiment of the present disclosure will be described with reference to FIG. 19.

FIG. 19 is a signal flow diagram illustrating a process of providing dynamic summing-up electronic book contents in the server based electronic book system according to the second embodiment of the present disclosure.

Referring to FIG. 19, firstly, when the client 1910 detects a request to buy an electronic book in operation 1911, it transmits a message for requesting to buy the electronic book to the electronic book content server 1920 in operation 1913. Here, the message for requesting to buy the electronic book includes a dynamic summing-up electronic book content flag, electronic book content information, a user profile, and the like. Referring to FIG. 19, it is assumed that the dynamic summing-up electronic book content flag indicates that the client intends to be provided with the dynamic summing-up electronic book contents.

The electronic book content server 1920 which receives the message for requesting to buy the electronic book detects a dynamic summing-up electronic book content flag included in the message for requesting buying the electronic book, and the dynamic-summable electronic book contents corresponding to the electronic book content information in operation 1915. Further, the electronic book content server 1920 edits the detected dynamic-summable electronic book contents in correspondence to the user profile, so as to create the dynamic summing-up electronic book contents in operation 1917. The electronic book content server 1920 provides the created dynamic summing-up electronic book contents to the client 1910 in operation 1919. The client 1910 outputs the dynamic summing-up electronic book contents provided from the electronic book content server 1920 in operation 1921.

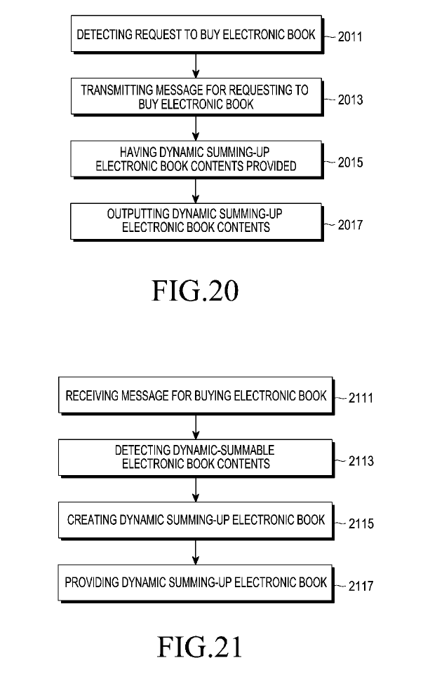

Hereinafter, an operation of the client 1910 of FIG. 19 will be described with reference to FIG. 20.

FIG. 20 is a flowchart illustrating an operation of the client 1910 of FIG. 19 according to an embodiment of the present disclosure.

Referring to FIG. 20, firstly, when the client 1910 detects a request to buy the electronic book in operation 2011, it proceeds to operation 2013. In operation 2013, the client 1910 transmits a message for requesting to buy the electronic book to the electronic book content server 2020, and it proceeds to operation 2015. Here, the message for requesting to buy the electronic book includes a dynamic summing-up electronic book content flag, electronic book content information, a user profile, and the like.

In operation 2015, the client 1910 is provided with the dynamic summing-up electronic book contents from the electronic book content server 2020, and it proceeds to operation 2017. In operation 2017, the client 1910 outputs the dynamic summing-up electronic book contents provided from the electronic book content server 1920.

Hereinafter, an operation of the electronic book content server 1920 of FIG. 19 will be described with reference to FIG. 21.

FIG. 21 is a flowchart illustrating an operating of an electronic book content server 1920 of FIG. 19 according to an embodiment of the present disclosure.

Referring to FIG. 21, firstly, when the electronic book content server 1920 receives the message for requesting to buy the electronic book from the client 1910 in operation 2111, it proceeds to operation 2113. Here, the message for requesting to buy the electronic book includes a dynamic summing-up electronic book content flag, electronic book content information, a user profile, and the like. In operation 2113, the electronic book content server 2120 detects the dynamic summing-up electronic book content flag included in the message for requesting to buy the electronic book, and the dynamic-summable electronic book contents corresponding to the electronic book content information, and it proceeds to operation 2115. In operation 2115, the electronic book content server 1920 edits the detected dynamic-summable electronic book contents in correspondence to the user profile, so as to create the dynamic summing-up electronic book contents, and then proceeds to operation 2117. In operation 2117, the electronic book content server 1920 provides the created dynamic summing-up electronic book contents to the client 1910.

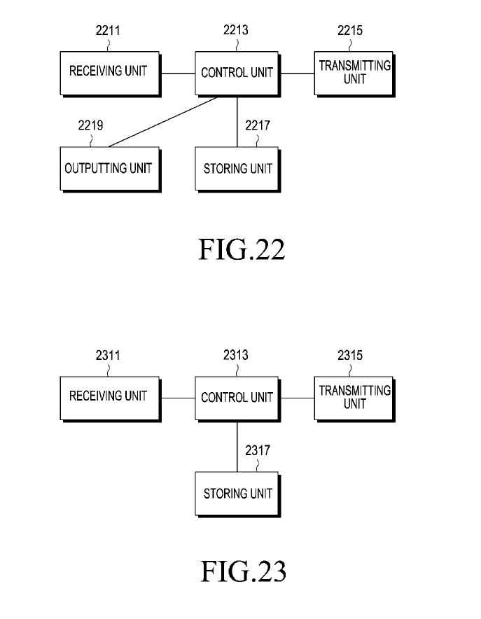

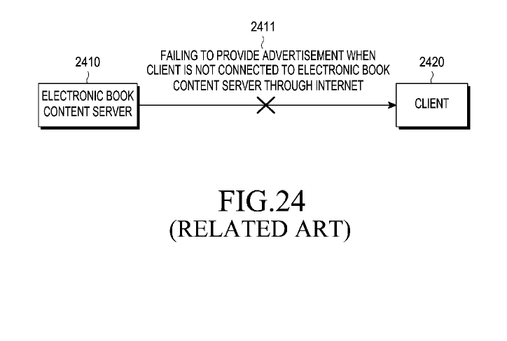

Next, an internal configuration of a client in the electronic book system according to an embodiment of the present disclosure will be described with reference to FIG. 22.

FIG. 22 is a view schematically illustrating an internal configuration of a client in an electronic book system according to an embodiment of the present disclosure.

Referring to FIG. 22, the client includes a receiving unit 2211, a control unit 2213, a transmitting unit 2215, a storing unit 2217, and an outputting unit 2219. The control unit 2213 controls an overall operation of the client, and especially, controls to perform an overall operation related to providing of the dynamic summing-up electronic book contents according to the first and second embodiments of the present disclosure. Here, since the overall operation related to the providing of the dynamic summing-up electronic book contents is identical to that described with reference to FIGS. 13 to 20, a detailed description of the overall operation related to the providing of the dynamic summing-up electronic book contents will be omitted.

The receiving unit 2211 receives various contents and messages from the electronic book server and the like under a control of the control unit 2213. Particularly, in the first embodiment of the present disclosure, the receiving unit 2211 receives the dynamic-summable electronic book contents from the electronic book server, and in the second embodiment of the present disclosure, the receiving unit 2211 receives the dynamic summing-up electronic book contents from the electronic book server. Since the dynamic-summable electronic book contents and the dynamic summing-up electronic book contents are received in an identical manner to that described with FIGS. 13 to 21, a detailed description of the reception of the dynamic-summable electronic book contents and the dynamic summing-up electronic book contents will be omitted.

The transmitting unit 2215 transmits various messages to the electronic book content server and the like under a control of the control unit 2213. Here, a message that the transmitting unit 2215 transmits may be, for example, a message for requesting to buy the electronic book, and the like. The storing unit 2217 stores various contents, various messages, and different kinds of data necessary for the operation of the client, which the receiving unit 2211 receives. The output unit 2219 outputs the dynamic summing-up electronic book contents under the control of the control unit 2213, and various output forms of the electronic book contents may be present.

On the other hand, although FIG. 22 shows a case where the receiving unit 2211, the control unit 2213, the transmitting unit 2215, the storing unit 2217, and the output unit 2219 are implemented as separate units, the receiving unit 2211, the control unit 2213, the transmitting unit 2215, the storing unit 2217, and the output unit 2219 may be implemented as one unit.

Next, an internal configuration of the client in the electronic book system according to an embodiment of the present disclosure will be described with reference to FIG. 23.

FIG. 23 is a view schematically illustrating the internal configuration of the electronic book content server in the electronic book system according to an embodiment of the present disclosure.

Referring to FIG. 23, the electronic book content server includes a receiving unit 2311, a control unit 2313, a transmitting unit 2315, and a storing unit 2317. The control unit 2313 controls an overall operation of the electronic book content server, and especially, controls to perform an overall operation related to providing of the dynamic summing-up electronic book contents according to the first and second embodiments of the present disclosure. Here, since the overall operation of the electronic book content server related to the providing of the dynamic summing-up electronic book contents is identical to that described with reference to FIGS. 13 to 21, a detailed description of the overall operation of the electronic book content server related to the providing of the dynamic summing-up electronic book contents will be omitted.

The receiving unit 2311 receives various messages from the client and the like under a control of the control unit 2313. For example, the message received from the client may be a message for requesting to buy the electronic book, and the like. The transmitting unit 2315 transmits various contents and messages to the client and the like under a control of the control unit 2313. Various contents transmitted and provided from the transmitting unit 2315 to the client may be the dynamic-summable electronic book contents in the first embodiment of the present disclosure, while the various contents may be the dynamic summing-up electronic book contents in the second embodiment of the present disclosure. Since the various contents are identical to those described with reference to FIGS. 13 to 21, a detailed description of the various contents will be omitted.

The storing unit 2317 stores a plurality of normal electronic book contents, dynamic-summable electronic book contents, various contents and messages received by the receiving unit 2311, different kinds of data necessary for an operation of the electronic book content server, and the like.

On the other hand, although FIG. 23 shows a case where the receiving unit 2311, the control unit 2313, the transmitting unit 2315, and the storing unit 2317 are implemented as separate units, the receiving unit 2311, the control unit 2313, the transmitting unit 2315, and the storing unit 2317 may be implemented as one unit.

The present disclosure proposes an apparatus and a method for providing an advertisement in an electronic book system.

The present disclosure proposes an apparatus and a method for providing an advertisement adaptable to a requirement of an advertisement provider in an electronic book system.

The present disclosure provides an apparatus and a method for providing an advertisement through a total of three embodiments including the first, second and third embodiments, and the apparatus and the method will be briefly described as follows.

Firstly, in the electronic book system according to the first embodiment of the present disclosure, the advertisement is provided in a non-clickable form (hereinafter, referred to as “non-clickable”), while in the electronic book system according to the second embodiment of the present disclosure, the advertisement is provided in a click and response form (hereinafter, referred to as “click and response”). In the electronic book system according to the third embodiment of the present disclosure, the advertisement is provided in the form of a click only (hereinafter, referred to as “click only”).

These will be described in more detail as follows.

Firstly, in the electronic book system according to the first embodiment of the present disclosure, the advertisement is provided in the form of only rendering the advertisement without separate interaction with a user of a client, such as a click.

Secondly, in the electronic book system according to the second embodiment of the present disclosure, the advertisement is provided in the form of providing an additional advertisement according to interaction with the user of the client, such as a click.

Thirdly, in the electronic book system according to the third embodiment of the present disclosure, the advertisement is provided without providing an additional advertisement although interaction with the user of the client, such as a click, may occur. Particularly, the apparatus and the method according to the third embodiment of the present disclosure may be effectively used when a specific advertisement provider performing the advertisement intends to collect data, for example, data such as a survey research, from clients provided with a corresponding advertisement.

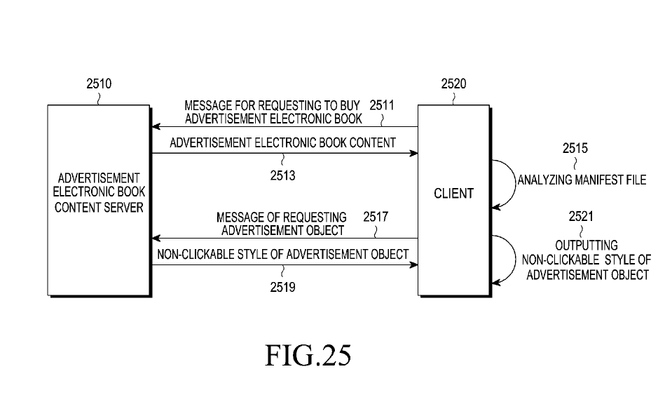

Hereinafter, a configuration of an electronic book system providing a non-clickable advertisement according to the first embodiment of the present disclosure will be described with reference to FIG. 25.

FIG. 25 is a view schematically illustrating a configuration of the electronic book system providing the non-clickable advertisement according to the first embodiment of the present disclosure.

Referring to FIG. 25, the electronic book system providing the non-clickable advertisement includes an advertisement electronic book content server 2510 and a client 2520. The electronic book advertisement content server 2510 manages a plurality of advertisement electronic book contents, and provides the advertisement electronic book content to the client 2520 in operation 2513 when receiving a message for requesting to buy the advertisement electronic book from the client 2520 in operation 2511. Here, the advertisement electronic book contents include a manifest file, and the manifest file includes configuration parameters related to the advertisement inserted in the corresponding advertisement electronic book contents. The configuration parameters include, for example, ID, AdToShow, Type, AdStyle, OnlineAdServerURL, offline-object, offline-offer-listURL, event-gathering-serverURL, and the like. Hereinafter, the ID, AdToShow, Type, AdStyle, OnlineAdServerURL, offline-object, offline-offer-listURL, event-gathering-serverURL, and the like, will be described as follows.

Firstly, the ID indicates an identifier for distinguishing each advertisement object inserted in the advertisement electronic book contents.

Secondly, the AdToShow indicates offline advertisement content output from the client.

Thirdly, the Type indicates whether a corresponding advertisement is an advertisement necessary for an online connection.

Fourthly, the AdStyle indicates a style of the advertisement. Here, the style of the advertisement includes, for example, a non-clickable style, a click and response style, and a click only style.

Fifthly, the OnlineAdServerURL indicates an address of an online advertisement server which provides online advertisement elements if the corresponding advertisement is the advertisement necessary for the online connection, i.e., the online advertisement.

Sixthly, the offline-object indicates an advertisement object which should be previously downloaded and provided to the client.

Seventhly, the offline-offer-listURL indicates all elements which a succeeding offer includes, for example, an address of an offer-list in which elements such as html, css, js, png, and the like, are listed.

Eighthly, the event-gathering-serverURL indicates an address of an online advertisement server to transmit a user input event occurring in the online advertisement object if the corresponding advertisement is the online advertisement.

Further, the manifest file may be included in advertisement electronic book contents in the form indicated in Table 3.

TABLE 3
META-INF/ container.xml - Note: includes multiple <rootfile> elements
[manifest.xml][metadata.xml][signatures.xml][encryption.xml][rights.xml]
[advertisements.xml]OEBPS/ Great Expectations.opf cover.html chapters/
chapter01.html chapter02.html ... other HTML files for the remaining
chapters ...PDF/
Great Expectations.pdf

In Table 3, “advertisements.xml” indicates a manifest file.

Further, the manifest file may be implemented in the form indicated in Table 4.

```
TABLE 4
The META-INF/advertisements.xml file:
<?xml version=″1.0″?>
<advertisements version=″1.0″
      xmlns=″um:oasis:names:tc:opendocument:xmlns:advertisements″>
  <adv:adData Id=″Author″ Type =″Offline″>
    <adv:AdToShow=″OEBPS/CarAd.html″/>

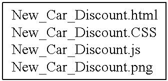

<adv:adData>
  <adv:adData Id=″NewBooks″ Type=″Online″AdStyle =
  ″non_clickable″>
    <adv: OnlineAdServerURL =″http://adserver.server.com″/>
<adv: offline-object =″OnlineAdServerURL/NewBooks.avi″/>
  </adv:adData>
  <adv:adData Id=″NewCar″ Type=″Online″ AdStyle=
  ″click_and_response″>
    <adv:OnlineAdServerURL=″http://adserver.server.con″/>
```

| | |
|---|---|
| <adv:offline-object=″OnlineAdServerURL/NewCar.jpg″/> <adv: offline-offer-listURL =″http://offerlist.server.com″/> </adv:adData> <adv:adData Id=″Survey″ Type=″Online″ AdStyle= ″click_Only″> | 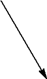 |

```
    <adv:OnlineAdServerURL=″http://adserver.server.com″/>
    <adv:offline-object=″OnlineAdServerURL/Survey.jpg″/>
    <adv: event-gathering-serverURL =″http://surveyserver.com″/>
  </adv:adData>
</advertisements>

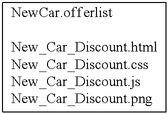

```

On the other hand, the client 2520 analyzes the manifest file included in the advertisement electronic book contents in operation 2515, and then transmits a message for requesting a non-clickable style of an advertisement object in correspondence to a result of the analysis to the advertisement electronic book content server 2510 in operation 2517. Then, the advertisement electronic book content server 2510 provides a non-clickable style of the advertisement object in correspondence to the message for requesting the advertisement object to the client 2520 in operation 2519. Next, the client 2520 outputs the non-clickable style of the advertisement object in operation 2521, if necessary.

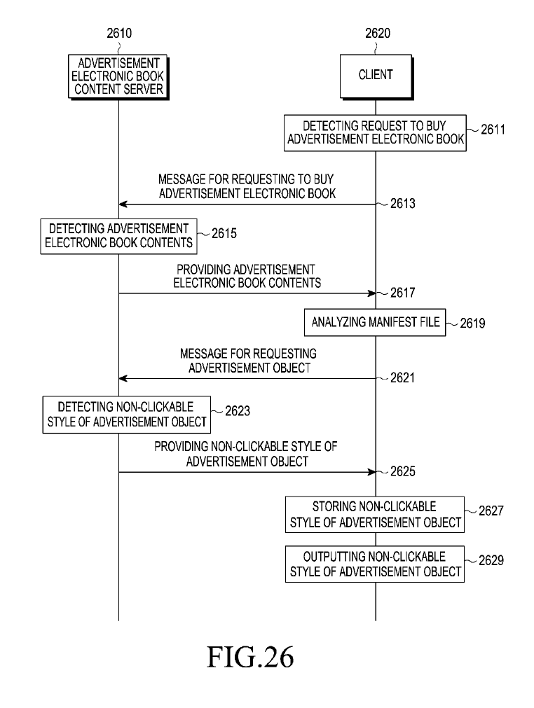

Hereinafter, a process of providing the advertisement in the non-clickable manner in the electronic book system according to the first embodiment of the present disclosure will be described with reference to FIG. 26.

FIG. 26 is a signal flow diagram illustrating a process of providing the advertisement in the non-clickable manner in the electronic book system according to the first embodiment of the present disclosure.

Referring to FIG. 26, firstly, when the client 2620 detects a request to buy an advertisement electronic book in operation 2611, it transmits a message for requesting to buy the advertisement electronic book to the advertisement electronic book content server 2610 in operation 2613. Here, the message for requesting to buy the advertisement electronic book includes advertisement electronic book content information, and the like, and the advertisement electric book content information may be, for example, an index of the advertisement electronic book content, a title of a book, and the like.

The advertisement electronic book content server 2610, which receives the message for requesting to buy the advertisement electronic book, detects the advertisement electronic book contents corresponding to the advertisement electronic book content information included in the message for requesting to buy the advertisement electronic book in operation 2615. Further, the advertisement electronic book content server 2610 provides the detected advertisement electronic book contents to the client 2620 in operation 2617.

The client 2620 analyzes a manifest file included in the advertisement electronic book contents provided from the advertisement electronic book content server 2610 in operation 2619, and transmits a message for requesting a non-clickable style of an advertisement object to the advertisement electronic book content server 2610 in correspondence to the analysis in operation 2621. The advertisement electronic book content server 2610, which receives a message for requesting the advertisement object, detects a non-clickable style of an advertisement object in correspondence to the message for requesting the advertisement object in operation 2623. The advertisement electronic book content server 2610 provides the detected non-clickable style of the advertisement object to the client 2620 in operation 2625, and the client 2620 stores the provided non-clickable style of the advertisement object in operation 2627. Then, the client 2620 outputs the non-clickable style of the advertisement object in operation 2629, if necessary.

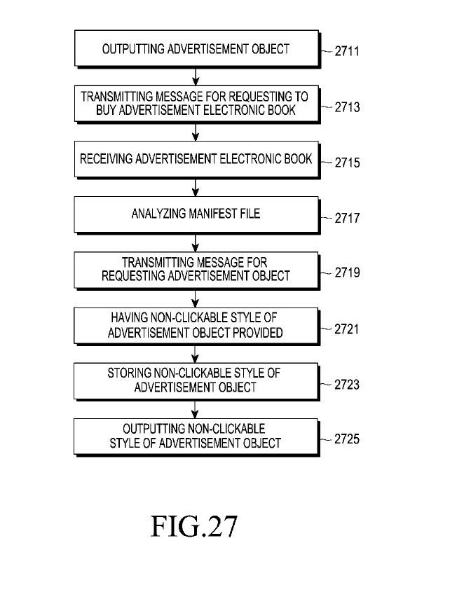

Hereinafter, an operation of the client 2620 of FIG. 26 will be described with reference to FIG. 27.

FIG. 27 is a flowchart illustrating an operation of the client 2620 of FIG. 26 according to an embodiment of the present disclosure.

Referring to FIG. 27, firstly, the client 2620 detects a request to buy the advertisement electronic book in operation 2711, and it proceeds to operation 2713. The client 2620 transmits a message for requesting to buy the advertisement electronic book to the advertisement electronic book content server 2610 in operation 2713, and it proceeds to operation 2715. The client 2620 is provided with the advertisement electronic book contents from the advertisement electronic book content sever 2610, and it proceeds to operation 2717. The client 2620 analyzes a manifest file included in the advertisement electronic book contents provided from the advertisement electronic book content server 2610 in operation 2717, and it proceeds to operation 2719. The client 2620 transmits a message for requesting a non-clickable style of an advertisement object to the advertisement electronic book content server 2610 in correspondence to a result of the analysis in operation 2719, and it proceeds to operation 2721. The client 2620 is provided with the non-clickable style of the advertisement object from the advertisement electronic book content sever 2610 in operation 2721, and it proceeds to operation 2723. The client 2620 stores the provided non-clickable style of the advertisement object in operation 2733, and it proceeds to operation 2725. Then, the client 2620 outputs the non-clickable style of the advertisement object in operation 2725, if necessary.

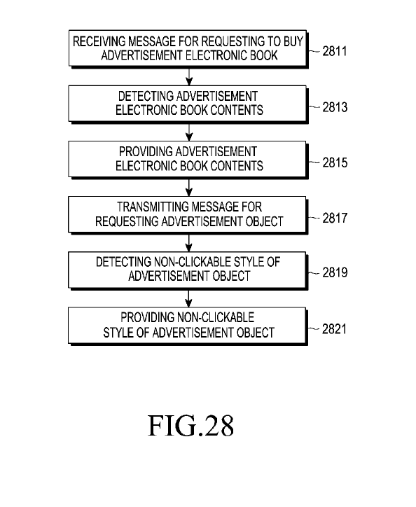

Hereinafter, an operation of the advertisement electronic book content server 2610 of FIG. 26 will be described with reference to FIG. 28.

FIG. 28 is a flowchart illustrating an operating process of the advertisement electronic book content server 2610 of FIG. 26 according to an embodiment of the present disclosure.

Referring to FIG. 28, firstly, when the advertisement electronic book content server 2610 receives the message for requesting to buy the advertisement electronic book from the electronic book content server 2610 in operation 2811, and it proceeds to operation 2813. The advertisement electronic book content server 2610 detects the advertisement electronic book contents corresponding to the advertisement electronic book content information included in the message for requesting to buy the advertisement electronic book in operation 2813, and it proceeds to operation 2815. Further, the advertisement electronic book content server 2610 provides the detected advertisement electronic book contents to the client 2620 in operation 2815, and it proceeds to operation 2817.

The advertisement electronic book content server 2610 transmits a message for requesting a non-clickable style of an advertisement object from the client 2620 in operation 2817, and it proceeds to operation 2819. The advertisement electronic book content server 2610 detects a non-clickable style of an advertisement object in correspondence to the message for requesting the advertisement object in operation 2819, and it proceeds to operation 2821. The advertisement electronic book content server 2610 provides the detected non-clickable style of the advertisement object to the client 2620 in operation 2821.

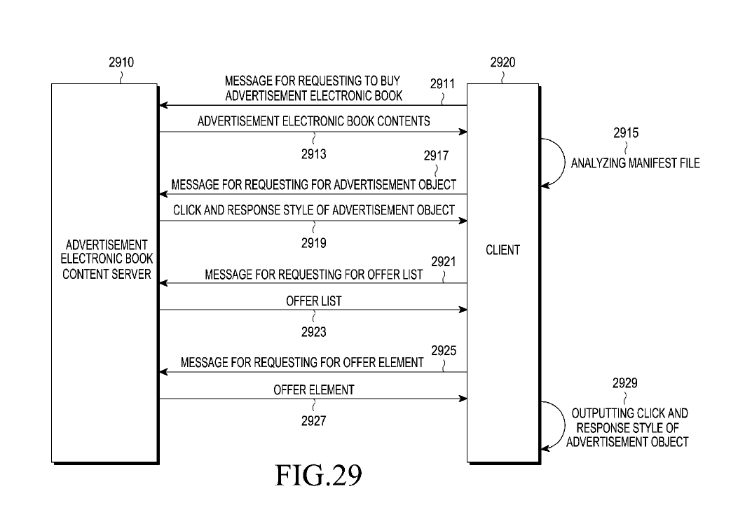

Hereinafter, a configuration of an electronic book system providing a click and response advertisement according to the second embodiment of the present disclosure will be described with reference to FIG. 29.

FIG. 29 is a view schematically illustrating a configuration of the electronic book system providing an advertisement in a click and response manner according to the second embodiment of the present disclosure.

Referring to FIG. 29, the electronic book system providing the advertisement in the click and response manner includes an advertisement electronic book content server 2910 and a client 2920. The electronic book advertisement content server 2910 manages a plurality of advertisement electronic book contents, and provides the advertisement electronic book content to the client 2920 in operation 2913 when receiving a message for requesting to buy the advertisement electronic book from the client 2920 in operation 2911. Here, the advertisement electronic book contents include a manifest file, and the manifest file includes configuration parameters related to the advertisement inserted in the corresponding advertisement electronic book contents.

On the other hand, the client 2920 analyzes the manifest file included in the advertisement electronic book contents in operation 2915, and then transmits a message for requesting the click and response style of an advertisement object in correspondence to a result of the analysis to the advertisement electronic book content server 2910 in operation 2917. Then, the advertisement electronic book content server 2910 provides the click and response style of the advertisement object in correspondence to the message for requesting the advertisement object to the client 2920 in operation 2919. The client 2920 transmits a message for requesting an offer list, i.e., a list of all elements including a succeeding offer to the advertisement electronic content server 2910 in operation 2921. The advertisement electronic book content server 2910, which receives a message for requesting the offer list from the client 2920, provides the offer list corresponding to the message for requesting the offer list to the client 2920 in operation 2923.

The client 2920, which is provided with the offer list, transmits a message for requesting all offer elements including a succeeding offer to the advertisement electronic book content server 2910 in operation 2925. The advertisement electronic book content server 2910, which receives a message for requesting the offer element from the client 2920, provides the offer elements corresponding to the message for requesting the offer elements to the client 2920 in operation 2927. Then, the client 2920 outputs the click and response style of the advertisement object in operation 2929, if necessary.

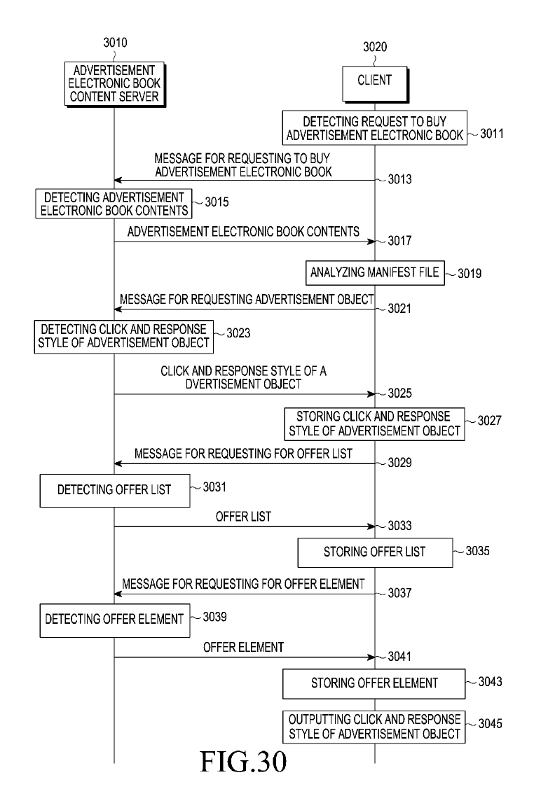

Hereinafter, a process of providing the advertisement in the electronic book system providing the advertisement in the click and response manner according to the second embodiment of the present disclosure will be described with reference to FIG. 30.

FIG. 30 is a signal flow diagram illustrating a process of providing an advertisement in the click and response manner in the electronic book system according to the second embodiment of the present disclosure.

Referring to FIG. 30, firstly, when the client 3020 detects a request to buy an advertisement electronic book in operation 3011, it transmits a message for requesting to buy the advertisement electronic book to the advertisement electronic book content server 3010 in operation 3013. Here, the message for requesting to buy the advertisement electronic book includes the advertisement electronic book content information, and the like, and the advertisement electric book content information may be, for example, an index of the advertisement electronic book content, a title of a book, and the like.

The advertisement electronic book content server 3010, which receives the message for requesting to buy the advertisement electronic book, detects the advertisement electronic book contents corresponding to the advertisement electronic book content information included in the message for requesting to buy the advertisement electronic book in operation 3015. Further, the advertisement electronic book content server 3010 provides the detected advertisement electronic book contents to the client 3020 in operation 3017.

The client 3020 analyzes a manifest file included in the advertisement electronic book contents provided from the advertisement electronic book content server 3010 in operation 3019, and transmits a message for requesting the click and response style of an advertisement object to the advertisement electronic book content server 3010 in correspondence to the analysis in operation 3021. The advertisement electronic book content server 3010, which receives a message for requesting the advertisement object, detects the click and response style of an advertisement object in correspondence to the message for requesting the advertisement object in operation 3023. The advertisement electronic book content server 3010 provides the detected click and response style of the advertisement object to the client 3020 in operation 3025, and the client 3020 stores the click and response style of the provided advertisement object in operation 3027.

Then, the client 3020 transmits a message for requesting the offer list to the advertisement electronic book content server 3010 in operation 3029, while the advertisement electronic book content server 3010, which receives the message for requesting the offer list from the client 3020, detects the offer list in operation 3031, and then provides the detected offer list to the client 3020 in operation 3033. The client 3020 stores the offer list which is provided from the advertisement electronic book content server 3010 in operation 3035, and transmits a message for requesting all offer elements, which a succeeding offer includes, to the advertisement electronic book content server 3010 in operation 3037.

The advertisement electronic book content server 3010, which receives a message for requesting the offer element from the client 3020, detects the offer elements corresponding to the message for requesting the offer elements in operation 3039, and provides the detected offer elements to the client 3020 in operation 3041. The client 3020 stores the provided offer elements in operation 3043, and then, it outputs the click and response style of the advertisement object in operation 3045, if necessary.

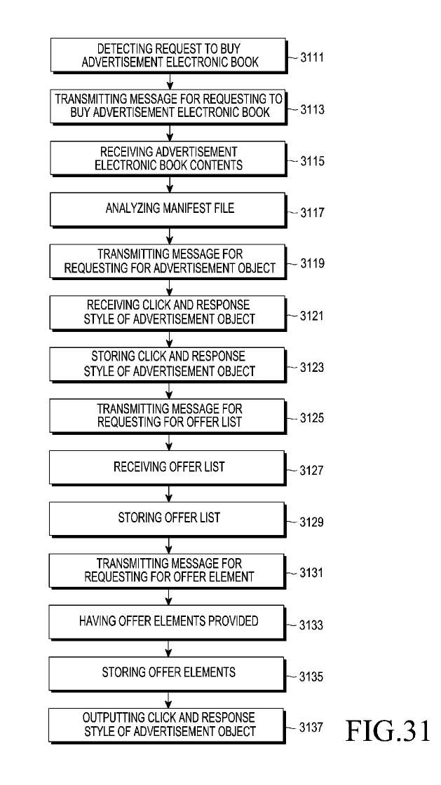

Hereinafter, an operation of the client 3020 of FIG. 30 will be described with reference to FIG. 31.

FIG. 31 is a flowchart illustrating an operating process in the client 3020 of FIG. 30 according to an embodiment of the present disclosure.

Referring to FIG. 31, firstly, the client 3020 detects a request to buy the advertisement electronic book in operation 3111, and it proceeds to operation 3113. The client 3020 transmits a message for requesting to buy the advertisement electronic book to the advertisement electronic book content server 3010 in operation 3113, and it proceeds to operation 3115. The client 3020 is provided with the advertisement electronic book contents from the advertisement electronic book content server 3010 in operation 3115, and it proceeds to operation 3117.

The client 3020 analyzes a manifest file included in the advertisement electronic book contents provided from the advertisement electronic book content server 3010 in operation 3117, and it proceeds to operation 3119. The client 3020 transmits a message for requesting the click and response style of the advertisement object to the advertisement electronic book content server 3010 in correspondence to a result of the analysis in operation 3119, and it proceeds to operation 3121. The client 3020 is provided with the click and response style of the advertisement object from the advertisement electronic book content sever 3010 in operation 3121, and it proceeds to operation 3123. The client 3020 stores the click and response style of the provided advertisement object in operation 3123, and it proceeds to operation 3125.

The client 3020 transmits a message for requesting the offer list to the advertisement electronic book content server 3010 in operation 3125, and it proceeds to operation 3127. The client 3020 is provided with the advertisement electronic book contents from the advertisement electronic book content sever 3010 in operation 3127, and it proceeds to operation 3129. The client 3020 stores the offer list provided from the advertisement electronic book content server 3010 in operation 3129, and it proceeds to operation 3131.

The client 3131, which is provided with the offer list, transmits a message for requesting all offer elements, which a succeeding offer includes, to the advertisement electronic book content server 3010 in operation 3131, and it proceeds to operation 3133. The client 3020 is provided with the offer elements from the advertisement electronic book content server 3010 in operation 3135, and it proceeds to operation 3133. The client 3020 stores the provided offer elements in operation 3135, and it proceeds to operation 3137. Then, the client 3020 outputs the click and response style of the advertisement object in operation 3137, if necessary.

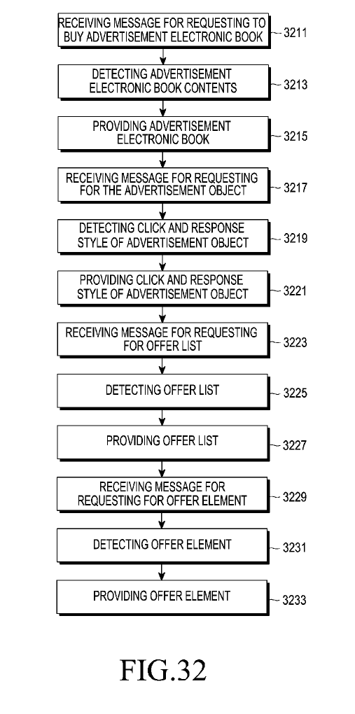

Hereinafter, an operation of the advertisement electronic book content server 3010 of FIG. 30 will be described with reference to FIG. 32.

FIG. 32 is a flowchart illustrating an operating process of the advertisement electronic book content server 3010 of FIG. 30 according to an embodiment of the present disclosure.

Referring to FIG. 32, firstly, when the advertisement electronic book content server 3010 receives the message for requesting to buy the advertisement electronic book from the client 3020 in operation 3211, and it proceeds to operation 3213. The advertisement electronic book content server 3010 detects the advertisement electronic book contents corresponding to the advertisement electronic book content information included in the message for requesting to buy the advertisement electronic book in operation 3213, and it proceeds to operation 3215. Further, the advertisement electronic book content server 3010 provides the detected advertisement electronic book contents to the client 3020 in operation 3215, and it proceeds to operation 3217.

The advertisement electronic book content server 3010 receives a message for requesting the click and response style of the advertisement object from the client 3220 in operation 3217, and it proceeds to operation 3219. The advertisement electronic book content server 3010 detects the click and response style of the advertisement object in correspondence to the message for requesting the advertisement object in operation 3219, and it proceeds to operation 3221. The advertisement electronic book content server 3010 provides the click and response style of the advertisement object to the client 3020 in operation 3221, and it proceeds to operation 3223. The advertisement electronic book content server 3010 receives a message for requesting the offer list from the client 3220 in operation 3223, and it proceeds to operation 3225.

The advertisement electronic book content server 3010 detects the offer list in operation 3225, and it proceeds to operation 3227. The advertisement electronic book content server 3010 provides the detected offer list to the client 3020 in operation 3227, and it proceeds to operation 3229. The advertisement electronic book content server 3010 receives a message for requesting all offer elements, which a succeeding offer includes, from the client 3020 in operation 3229, and it proceeds to operation 3231. The advertisement electronic book content server 3010 detects offer elements corresponding to a message for requesting the offer elements in operation 3231, and it proceeds to operation 3233. The advertisement electronic book content server 3010 provides the detected offer elements to the client 3020 in operation 3233.

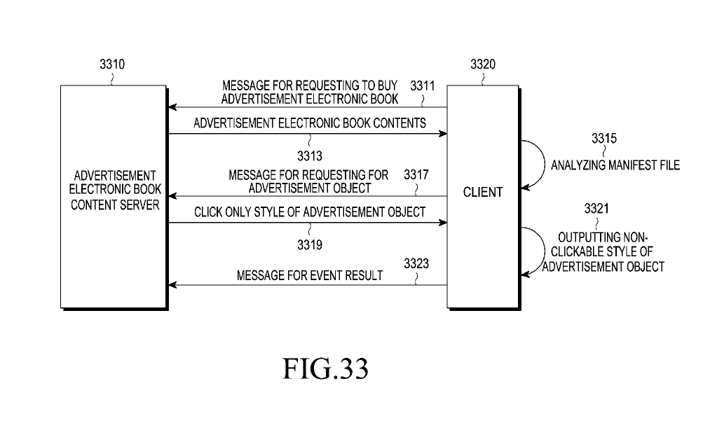

Hereinafter, a configuration of an electronic book system providing the advertisement in the click-only manner according to the third embodiment of the present disclosure will be described with reference to FIG. 33.

FIG. 33 is a view schematically illustrating the configuration of the electronic book system providing the advertisement in the click-only manner according to the third embodiment of the present disclosure.

Referring to FIG. 33, the electronic book system providing the advertisement in the click-only manner includes an advertisement electronic book content server 3310 and a client 3320. The electronic book advertisement content server 3310 manages a plurality of advertisement electronic book contents, and provides the advertisement electronic book contents to the client 3320 in operation 3313 when receiving a message for requesting to buy the advertisement electronic book from the client 3320 in operation 3311. The client 3320 analyzes a manifest file included in the advertisement electronic book contents in operation 3315, and then, transmits a message for requesting the click-only style of the advertisement object to the advertisement electronic book content server 3310 in correspondence to a result of the analysis in operation 3317.

Then, the advertisement electronic book content server 3310 provides the click-only style of the advertisement object in correspondence to the message for requesting the advertisement object to the client 3320 in operation 3319. Then, the client 3320 outputs the non-clickable style of the advertisement object in operation 3321, if necessary, and transmits a message including an event result, which is input by the user of the client 3320 for the output advertisement object, to the advertisement electronic book content server 3310 in operation 3323.

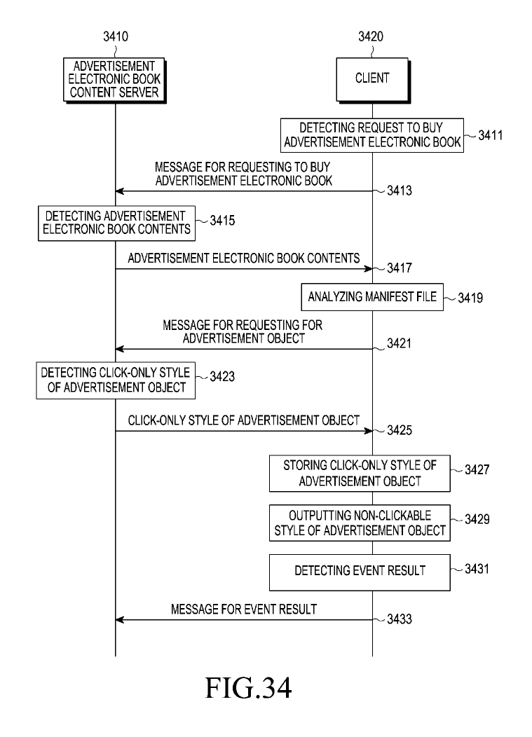

Hereinafter, a process of providing the advertisement in the click-only manner in the electronic book system according to the third embodiment of the present disclosure will be described with reference to FIG. 34.

FIG. 34 is a signal flow diagram illustrating a process of providing the advertisement in the click-only manner in the electronic book system according to the third embodiment of the present disclosure.

Referring to FIG. 34, firstly, when the client 3420 detects a request to buy an advertisement electronic book in operation 3411, it transmits a message for requesting to buy the advertisement electronic book to the advertisement electronic book content server 3410 in operation 3413. The advertisement electronic book content server 3410, which receives the message for requesting to buy the advertisement electronic book, detects the advertisement electronic book contents corresponding to the advertisement electronic book content information included in the message for requesting to buy the advertisement electronic book in operation 3415. Further, the advertisement electronic book content server 3410 provides the detected advertisement electronic book contents to the client 3420 in operation 3417.

The client 3420 analyzes a manifest file included in the advertisement electronic book contents provided from the advertisement electronic book content server 3410 in operation 3419, and transmits a message for requesting the click-only style of the advertisement object to the advertisement electronic book content server 3010 in correspondence to the analysis in operation 3421. The advertisement electronic book content server 3410, which receives a message for requesting the advertisement object, detects the click-only style of the advertisement object in correspondence to the message for requesting the advertisement object in operation 3423.

The advertisement electronic book content server 3410 provides the detected click-only style of the advertisement object to the client 3420 in operation 3425, and the client 3420 stores the click-only style of the provided advertisement object in operation 3427. Then, the client 3420 outputs the non-clickable style of the advertisement object in operation 3429, and detects a result of an event input by the user of the client 3420 in operation 3431. Next, the client 3420 transmits the message including the result of the detected event to the advertisement electronic book content server 3410 in operation 3433.

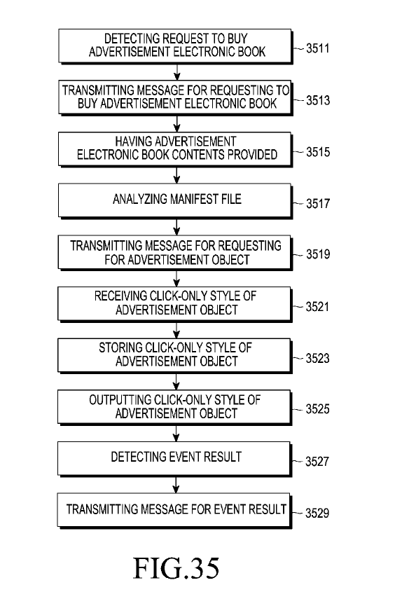

Hereinafter, an operation of the client 3420 of FIG. 34 will be described with reference to FIG. 35.

FIG. 35 is a flowchart illustrating an operation of the client 3420 of FIG. 34 according to an embodiment of the present disclosure.

Referring to FIG. 35, firstly, the client 3420 detects a request to buy the advertisement electronic book in operation 3511, and it proceeds to operation 3513. The client 3420 transmits a message for requesting to buy the advertisement electronic book to the advertisement electronic book content server 3410 in operation 3513, and it proceeds to operation 3515. The client 3420 is provided with the advertisement electronic book contents from the advertisement electronic book content sever 3410 in operation 3515, and it proceeds to operation 3517.

The client 3420 analyzes a manifest file included in the advertisement electronic book contents provided from the advertisement electronic book content server 3410 in operation 3517, and it proceeds to operation 3519. The client 3420 transmits a message for requesting the click-only style of the advertisement object to the advertisement electronic book content server 3410 in correspondence to a result of the analysis in operation 3519, and it proceeds to operation 3521. The client 3420 is provided with the click-only style of the advertisement object from the advertisement electronic book content sever 3410 in operation 3521, and it proceeds to operation 3523.

The client 3420 stores the click-only style of the provided advertisement object in operation 3523, and it proceeds to operation 3525. The client 3420 outputs the click-only style of the advertisement object in operation 3525 if necessary, and it proceeds to operation 3527. The client 3420 detects a result of an event input by the user in operation 3527, and it proceeds to operation 3529. Next, the client 3420 transmits the message including the result of the detected event to the advertisement electronic book content server 3410 in operation 3529.

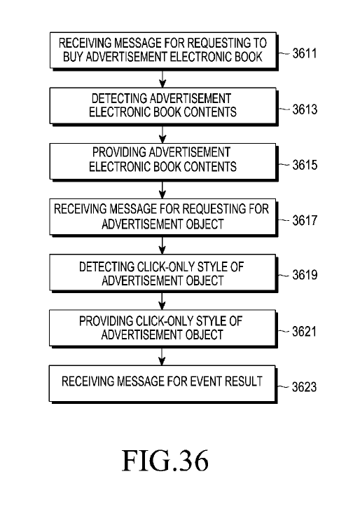

Hereinafter, an operation of the advertisement electronic book content server 3410 of FIG. 34 will be described with reference to FIG. 36.

FIG. 36 is a flowchart illustrating an operating process of the advertisement electronic book content server 3410 of FIG. 34 according to an embodiment of the present disclosure.

Referring to FIG. 36, firstly, when the advertisement electronic book content server 3410 receives the message for requesting to buy the advertisement electronic book from the client 3420 in operation 3611, and it proceeds to operation 3613. The advertisement electronic book content server 3410 detects the advertisement electronic book contents corresponding to the advertisement electronic book content information included in the message for requesting to buy the advertisement electronic book in operation 3613, and it proceeds to operation 3615. Further, the advertisement electronic book content server 3410 provides the detected advertisement electronic book contents to the client 3420 in operation 3615, and it proceeds to operation 3617.

The advertisement electronic book content server 3410 receives a message for requesting the click-only style of the client 3420 in operation 3617, and it proceeds to operation 3619. The advertisement electronic book content server 3410 detects the click-only style of the advertisement object in correspondence to the message for requesting the advertisement object in operation 3619, and it proceeds to operation 3621. The advertisement electronic book content server 3410 provides the click-only style of the detected advertisement object to the client 3420 in operation 3621, and it proceeds to operation 3623. Next, the advertisement electronic book content server 3410 receives the message including the result of the event from the client 3420 in operation 3623.

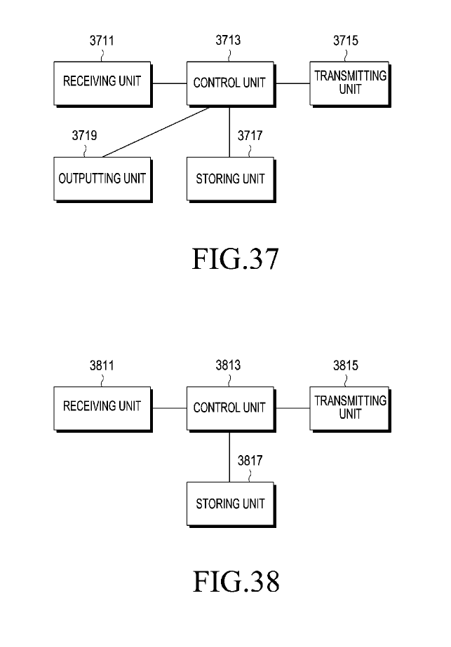

Next, an internal configuration of the client in the electronic book system according to an embodiment of the present disclosure will be described with reference to FIG. 37.

FIG. 37 is a view schematically illustrating the internal configuration of the client in the electronic book system according to an embodiment of the present disclosure.

Referring to FIG. 37, the client includes a receiving unit 3711, a control unit 3713, a transmitting unit 3715, a storing unit 3717, and an outputting unit 3719. The control unit 3713 controls an overall operation of the client, and especially, controls to perform an overall operation related to providing of the advertisement according to the first, second, and third embodiments of the present disclosure. Here, since the overall operation related to the providing of the advertisement is identical to that described with reference to FIGS. 25 to 36, a detailed description of the overall operation related to the providing of the advertisement will be omitted.

The receiving unit 3711 receives various contents and messages from the advertisement electronic book server and the like under a control of the control unit 3713. Here, since the various contents and messages which the receiving unit 3711 receives are identical to those described with reference to FIGS. 25 to 36, a detailed description of the various contents and messages will be omitted.

The transmitting unit 3715 transmits various messages to the electronic book content server and the like under a control of the control unit 3713. Here, since the various messages which the transmitting unit 3715 transmits are identical to those described with reference to FIGS. 25 to 36, a detailed description of the various messages will be omitted. The storing unit 3717 stores various contents, various messages, and different kinds of data necessary for the operation of the client, which the receiving unit 3711 receives. The output unit 3719 outputs the advertisement object under the control of the control unit 3713, and various output forms of the advertisement object may be present.

On the other hand, although FIG. 37 shows a case where the receiving unit 3711, the control unit 3713, the transmitting unit 3715, the storing unit 3717, and the output unit 3719 are implemented in separate units, the receiving unit 3711, the control unit 3713, the transmitting unit 3715, the storing unit 3717, and the output unit 3719 may be implemented as one unit.

Next, the internal configuration of the advertisement electronic book server in the electronic book system according to an embodiment of the present disclosure will be described with reference to FIG. 38.

FIG. 38 is a view schematically illustrating the internal configuration of the advertisement electronic book content server in the electronic book system according to an embodiment of the present disclosure.

Referring to FIG. 38, the advertisement electronic book content server includes a receiving unit 3811, a control unit 3813, a transmitting unit 3815, and a storing unit 3817. The control unit 3813 controls an overall operation of the advertisement electronic book content server, and especially, controls to perform an overall operation related to providing of the advertisement according to the first, second, and third embodiments of the present disclosure. Here, since the overall operation related to the providing of the advertisement is identical to that described with reference to FIGS. 25 to 36, a detailed description of the overall operation related to the providing of the advertisement will be omitted.

The receiving unit 3811 receives various messages from the client and the like under a control of the control unit 3813. Here, since the various messages, which the receiving unit 3811 receives, are identical to those described with reference to FIGS. 25 to 36, a detailed description of the various messages will be omitted. The transmitting unit 3815 transmits various contents and messages to the client and the like under a control of the control unit 3813. Since the various contents transmitted and provided from the transmitting unit 3815 to the client and the various messages transmitted from the transmitting unit 3815 are identical to those described with reference to FIGS. 25 to 36, a detailed description of the various contents and messages will be omitted. The storing unit 3817 stores a plurality of advertisement electronic book contents, various contents and messages which the receiving unit 3811 receives, and various data necessary for an operation of the advertisement electronic book content server.

On the other hand, although FIG. 38 shows a case where the receiving unit 3811, the control unit 3813, the transmitting unit 3815, and the storing unit 3817 are implemented in separate units, the receiving unit 3811, the control unit 3813, the transmitting unit 3815, and the storing unit 3817 may be implemented as one unit.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. A method of providing multiplay electronic book contents of a client in an electronic book system, the method comprising:
receiving multi-playable electronic book contents, which are electronic book contents including a multiplay profile and multiplay characteristic information, from an electronic book content server; and
editing the multi-playable electronic book contents in correspondence to a user profile, so as to create the multiplay electronic book contents,
wherein the multiplay profile includes at least one multiplay parameter which is characteristic information of corresponding electronic book contents, the multiplay characteristic information indicates information tagging whether sub-contents which the multi-playable electronic book contents include correspond to at least one multiplay parameter respectively, and the user profile includes at least one user parameter which is characteristic information of the electronic book contents with which the client intends to be provided.

2. A method of providing multiplay electronic book contents of an electronic book content server in an electronic book system, the method comprising:
providing multi-playable electronic book contents, which are electronic book contents including a multiplay profile and multiplay characteristic information, to a client,
wherein the multiplay profile includes at least one multiplay parameter which is characteristic information of corresponding electronic book contents, the multiplay characteristic information indicates information tagging whether sub-contents which the multi-playable electronic book contents include correspond to at least one multiplay parameter respectively, and the user profile includes at least one user parameter which is characteristic information of the electronic book contents with which the client intends to be provided.

3. A method of providing multiplay electronic book contents of a client in an electronic book system, the method comprising:
receiving multiplay electronic book contents from an electronic book content server,
wherein the multiplay electronic book contents are created by editing multi-playable electronic book contents, which are electronic book contents including a multiplay profile and multiplay characteristic information, in correspondence to a user profile, and wherein the multiplay profile includes at least one multiplay parameter which is characteristic information of corresponding electronic book contents, the multiplay characteristic information indicates information tagging whether sub-contents which the multi-playable electronic book contents include correspond to at least one multiplay parameter respectively, and the user profile includes at least one user parameter which is characteristic information of the electronic book contents with which the client intends to be provided.

4. A method of providing multiplay electronic book contents of an electronic book content server in an electronic book system, the method comprising:
creating multiplay electronic book contents by editing multi-playable electronic book contents, which are electronic book contents including a multiplay profile and multiplay characteristic information, in correspondence to a user profile; and
providing the multiplay electronic book contents to the client,
wherein the multiplay profile includes at least one multiplay parameter which is characteristic information of corresponding electronic book contents, the multiplay characteristic information indicates information tagging whether sub-contents which the multi-playable electronic book contents include correspond to at least one multiplay parameter respectively, and the user profile includes at least one user parameter which is characteristic information of the electronic book contents with which the client intends to be provided.

5. A client in an electronic book system, the client comprising:
a receiving unit which receives multi-playable electronic book contents, which are electronic book contents including a multiplay profile and multiplay characteristic information, from an electronic book content server; and
a control unit which edits the multi-playable electronic book contents in correspondence to a user profile, so as to create the multiplay electronic book contents,
wherein the multiplay profile includes at least one multiplay parameter which is characteristic information of corresponding electronic book contents, the multiplay characteristic information indicates information tagging a multiplay parameter which sub-contents which the multi-playable electronic book contents include correspond to among at least one multiplay parameter respectively, and the user profile includes at least one user parameter which is characteristic information of the electronic book contents with which the client intends to be provided.

6. An electronic book content server in an electronic book system, server comprising:
a transmitting unit which provides multi-playable electronic book contents, which are electronic book contents including a multiplay profile and multiplay characteristic information, to a client,
wherein the multiplay profile includes at least one multiplay parameter which is characteristic information of corresponding electronic book contents, the multiplay characteristic information indicates information tagging a multiplay parameter which sub-contents which the multi-playable electronic book contents include correspond to among at least one multiplay parameter respectively, and the user profile includes at least one user parameter which is characteristic information of the electronic book contents with which the client intends to be provided.

7. A client in an electronic book system, the client comprising:
a receiving unit which receives multiplay electronic book contents from an electronic book content server,
wherein the multiplay electronic book contents are created by editing multi-playable electronic book contents, which are electronic book contents including a multiplay profile and multiplay characteristic information, in correspondence to a user profile, and wherein the multiplay profile includes at least one multiplay parameter which is characteristic information of corresponding electronic book contents, the multiplay characteristic information indicates information tagging whether sub-contents which the multi-playable electronic book contents include correspond to at least one multiplay parameter respectively, and the user profile includes at least one user parameter which is characteristic information of the electronic book contents with which the client intends to be provided.

8. An electronic book content server in an electronic book system, the server comprising:
a control unit which creates multiplay electronic book contents by editing multi-playable electronic book contents, which are electronic book contents including a multiplay profile and multiplay characteristic information, in correspondence to a user profile; and
a transmitting unit which provides the multiplay electronic book contents to the client,
wherein the multiplay profile includes at least one multiplay parameter which is characteristic information of corresponding electronic book contents, the multiplay characteristic information indicates information tagging whether sub-contents which the multi-playable electronic book contents include correspond to at least one multiplay parameter respectively, and the user profile includes at least one user parameter which is characteristic information of the electronic book contents with which the client intends to be provided.

9. A method of providing dynamic summing-up electronic book contents of a client in an electronic book system, the method comprising:
receiving dynamic-summable electronic book contents, which are electronic book contents including a dynamic summing-up profile and dynamic summing-up characteristic information, from an electronic book content server; and
editing the dynamic-summable electronic book contents in correspondence to a user profile, so as to create the dynamic summing-up electronic book contents,
wherein the dynamic summing-up profile includes at least one dynamic summing-up parameter which is characteristic information of corresponding electronic book contents, the dynamic summing-up characteristic information indicates configuration information of each of objects which the dynamic-summable electronic contents include, and the user profile includes at least one user parameter which is characteristic information of electronic book contents with which the client intends to be provided.

10. A method of providing dynamic summing-up electronic book contents of an electronic book content server in an electronic book system, the method comprising:
providing dynamic-summable electronic book contents, which are electronic book contents including a dynamic summing-up profile and dynamic summing-up characteristic information, to a client,
wherein the dynamic summing-up profile includes at least one dynamic summing-up parameter which is characteristic information of corresponding electronic book contents, the dynamic summing-up characteristic information indicates configuration information of each of objects which the dynamic-summable electronic book contents include, and the user profile includes at least one user parameter which is characteristic information of electronic book contents with which the client intends to be provided.

11. A method of dynamic summing-up electronic book contents of a client in an electronic book system, the method comprising:
receiving dynamic summing-up electronic book contents from an electronic book content server,
wherein the dynamic summing-up electronic book contents are created by editing dynamic-summable electronic book contents, which are electronic book contents including a dynamic summing-up profile and dynamic summing-up characteristic information, in correspondence to a user profile, and wherein the dynamic summing-up profile includes at least one dynamic summing-up parameter which is characteristic information of corresponding electronic book contents, the dynamic summing-up characteristic information indicates configuration information of each of objects which the dynamic-summable electronic book contents include, and the user profile includes at least one user parameter which is characteristic information of electronic book contents with which the client intends to be provided.

12. A method of providing dynamic summing-up electronic book contents of an electronic book content server in an electronic book system, the method comprising:
creating the dynamic summing-up electronic book contents by editing dynamic-summable electronic book contents, which are electronic book contents including a dynamic summing-up profile and dynamic summing-up characteristic information, in correspondence to a user profile; and
providing the dynamic summing-up electronic book contents to the client,
wherein the dynamic summing-up profile includes at least one dynamic summing-up parameter which is characteristic information of corresponding electronic book contents, the dynamic summing-up characteristic information indicates configuration information of each of objects which the dynamic-summable electronic book contents include, and the user profile includes at least one user parameter which is characteristic information of electronic book contents with which the client intends to be provided.

13. A client in an electronic book system, the client comprising:
a receiving unit which receives dynamic-summable electronic book contents, which are electronic book contents including a dynamic summing-up profile and dynamic summing-up characteristic information, from an electronic book content server; and
a control unit which edits the dynamic-summable electronic book contents in correspondence to a user profile, so as to create the dynamic summing-up electronic book contents,
wherein the dynamic summing-up profile includes at least one dynamic summing-up parameter which is characteristic information of corresponding electronic book contents, the dynamic summing-up characteristic information indicates configuration information of each of objects which the dynamic-summable electronic contents include, and the user profile includes at least one user parameter which is characteristic information of electronic book contents with which the client intends to be provided.

14. An electronic book content server in an electronic book system, the server comprising:
providing dynamic-summable electronic book contents, which are electronic book contents including a dynamic summing-up profile and dynamic summing-up characteristic information, to a client,
wherein the dynamic summing-up profile includes at least one dynamic summing-up parameter which is characteristic information of corresponding electronic book contents, the dynamic summing-up characteristic information indicates configuration information of each of objects which the dynamic-summable electronic book contents include, and the user profile includes at least one user parameter which is characteristic information of electronic book contents with which the client intends to be provided.

15. A client in an electronic book system, the client comprising:
a receiving unit which receives dynamic summing-up electronic book contents from an electronic book content server,
wherein the dynamic summing-up electronic book contents are created by editing dynamic-summable electronic book contents, which are electronic book contents including a dynamic summing-up profile and dynamic summing-up characteristic information, in correspondence to a user profile, and wherein the dynamic summing-up profile includes at least one dynamic summing-up parameter which is characteristic information of corresponding electronic book contents, the dynamic summing-up characteristic information indicates configuration information of each of objects which the dynamic-summable electronic book contents include, and the user profile includes at least one user parameter which is characteristic information of electronic book contents with which the client intends to be provided.

16. An electronic book content server in an electronic book system, the server comprising:
a control unit which creates dynamic summing-up electronic book contents by editing the dynamic-summable electronic book contents, which are electronic book contents including a dynamic summing-up profile and dynamic summing-up characteristic information, in correspondence to a user profile; and
a transmitting unit which provides the dynamic summing-up electronic book contents to the client,
wherein the dynamic summing-up profile includes at least one dynamic summing-up parameter which is characteristic information of corresponding electronic book contents, the dynamic summing-up characteristic information indicates configuration information of each of objects which the dynamic-summable electronic book contents include, and the user profile includes at least one user parameter which is characteristic information of electronic book contents with which the client intends to be provided.

17. A method of providing an advertisement of a client in an electronic book system, the method comprising:
receiving advertisement electronic book contents, which includes a manifest file having configuration parameters related to an advertisement inserted in corresponding advertisement electronic book contents, from an advertisement electronic book content server;
transmitting a message for requesting a non-clickable style of an advertisement object to the advertisement electronic book content server after analyzing the manifest file; and
having a non-clickable style of the advertisement object provided from the advertisement electronic book content server.

18. A method of providing an advertisement of an advertisement electronic book content server in an electronic book system, the method comprising:
providing advertisement electronic book contents, which includes a manifest file having configuration parameters related to an advertisement inserted in corresponding advertisement electronic book contents, to a client;
receiving a message for requesting a non-clickable style of advertisement object from the client; and
providing a non-clickable style of the advertisement object to the client.

19. A client in an electronic book system, the client comprising:
a receiving unit which receives advertisement electronic book contents, which includes a manifest file having configuration parameters related to an advertisement inserted in corresponding advertisement electronic book contents, from an advertisement electronic book content server, and which receives a non-clickable style of an advertisement object from the advertisement electronic book content server;
a control unit which analyzes the manifest file; and
a transmitting unit which transmits a message for requesting the non-clickable style of the advertisement object to the advertisement electronic book content server.

20. An advertisement electronic book content server in an electronic book system, the server comprising:
a transmitting unit which provides advertisement electronic book contents, which includes a manifest file having configuration parameters related to an advertisement inserted in corresponding advertisement electronic book contents, to a client, and which provides a non-clickable style of an advertisement object to the client; and
a receiving unit which receives a message for requesting the non-clickable style of the advertisement object from the client.

21. A method of providing an advertisement of a client in an electronic book system, the method comprising:
receiving advertisement electronic book contents, which includes a manifest file having configuration parameters related to an advertisement inserted in corresponding advertisement electronic book contents, from an advertisement electronic book content server;
transmitting a message for requesting a click and response style of an advertisement object to the advertisement electronic book content server after analyzing the manifest file;
receiving the click and response style of the advertisement object from the advertisement electronic book content server;
transmitting a message for requesting an offer list which is a list of all elements which a succeeding offer includes, to the advertisement electronic book content server;
having the offer list provided from the advertisement electronic book content server;
transmitting a message for requesting all offer elements which the succeeding offer includes, to the advertisement electronic book content server; and
receiving all offer elements, which the succeeding offer includes, from the advertisement electronic book content server.

22. A method of providing an advertisement of an advertisement electronic book content server in an electronic book system, the method comprising:
providing advertisement electronic book contents, which includes a manifest file having configuration parameters related to an advertisement inserted in corresponding advertisement electronic book contents, to a client;
receiving a message for requesting a click and response style of an advertisement object from the client;
providing the click and response style of an advertisement object to the client;
receiving a message for requesting an offer list which is a list of all elements which a succeeding offer includes, from the client;
providing the offer list to the client;
receiving a message for requesting all elements, which the succeeding offer includes, from the client; and
providing all offer elements, which the succeeding offer includes, to the client.

23. A client in an electronic book system, the client comprising:
a transmitting unit;
a receiving unit; and
a control unit,
wherein the receiving unit receives advertisement electronic book contents, which includes a manifest file having configuration parameters related to an advertisement inserted in corresponding advertisement electronic book contents, from an advertisement electronic book content server, the control unit analyzes the manifest file, the transmitting unit transmits a message for requesting a click and response style of an advertisement object to the advertisement electronic book content server, the receiving unit receives the click and response style of the advertisement object from the advertisement electronic book content server, the transmitting unit transmits a message for requesting an offer list which is a list of all elements which a succeeding offer includes, to the advertisement electronic book content server, the receiving unit receives the offer list from the advertisement electronic book content server, the transmitting unit transmits a message for requesting all offer elements which the succeeding offer includes, to the advertisement electronic book content server, and the receiving unit receives all elements, which the succeeding offer includes, from the advertisement electronic book content server.

24. An advertisement electronic book content server in an electronic book system, the server comprising:
a transmitting unit;
a receiving unit; and
a control unit,
wherein the transmitting unit provides advertisement electronic book contents, which includes a manifest file having configuration parameters related to an advertisement inserted in corresponding advertisement electronic book contents, to a client, the receiving unit receives a message for requesting a click and response style of an advertisement object from the client, the transmitting unit provides the click and response style of an advertisement object to the client, the receiving unit receives a message for requesting an offer list which is a list of all elements which a succeeding offer includes, from the client, the transmitting unit provides the offer list to the client, the receiving unit receives a message for requesting all offer elements, which the succeeding offer includes, from the client, and the transmitting unit provides all offer elements, which the succeeding offer includes, to the client.

25. A method of providing an advertisement of a client in an electronic book system, the method comprising:
receiving advertisement electronic book contents, which includes a manifest file having configuration parameters related to an advertisement inserted in corresponding advertisement electronic book contents, from an advertisement electronic book content server;
transmitting a message for requesting a click-only style of the advertisement object to the advertisement electronic book content server after analyzing the manifest file;
receiving the click-only style of the advertisement object from the advertisement electronic book content server;
outputting the click-only style of the advertisement object; and
transmitting a message including a result of an event for the click-only style of the output advertisement object to the advertisement electronic book content server.

26. A method of providing an advertisement of an advertisement electronic book content server in an electronic book system, the method comprising:
providing advertisement electronic book contents, which includes a manifest file having configuration parameters related to an advertisement inserted in corresponding advertisement electronic book contents, to a client;
receiving a message for requesting a click-only style of advertisement object from the client;
providing the click-only style of the advertisement object to the client; and
receiving a message including a result of an event for the click-only style of the advertisement object from the client.

27. A client in an electronic book system, the client comprising:
a transmitting unit;
a control unit;
a receiving unit; and
an outputting unit,
wherein the receiving unit receives advertisement electronic book contents, which includes a manifest file having configuration parameters related to an advertisement inserted in corresponding advertisement electronic book contents, from an advertisement electronic book content server, the transmitting unit transmits a message for requesting a click-only style of the advertisement object to the advertisement electronic book content server after analyzing the manifest file, the receiving unit receives the click-only style of the advertisement object from the advertisement electronic book content server, the outputting unit outputs the click-only style of the advertisement object, and the transmitting unit transmits a message including a result of an event for the click-only style of the output advertisement object to the advertisement electronic book content server.

28. An advertisement electronic book content server in an electronic book system, the advertisement electronic book content server comprising:
a transmitting unit;
a receiving unit; and
a control unit,
wherein the transmitting unit provides advertisement electronic book contents, which includes a manifest file having configuration parameters related to an advertisement inserted in corresponding advertisement electronic book contents, to a client, the receiving unit receives a message for requesting a click-only style of an advertisement object from the client, the transmitting unit provides the click-only style of the advertisement object to the client, and the receiving unit receives a message including a result of an event for the click-only style of the advertisement object from the client.
